(19) United States
(12) Patent Application Publication
(10) Pub. No.: US 2017/0010794 A1
(43) Pub. Date: Jan. 12, 2017

(54) ELECTRONIC DEVICE, AND METHOD FOR CHANGING ICON IN THE ELECTRONIC DEVICE

(71) Applicant: Samsung Electronics Co., Ltd., Gyeonggi-do (KR)

(72) Inventors: Sung-Jae CHO, Seoul (KR); Kyung-Nam KIM, Gyeonggi-do (KR); Nam-Il KIM, Gyeonggi-do (KR); Yo-Han LEE, Gyeonggi-do (KR); Yu-Jeong JEON, Gyeonggi-do (KR)

(21) Appl. No.: 15/205,110

(22) Filed: Jul. 8, 2016

(30) Foreign Application Priority Data
Jul. 8, 2015 (KR) 10-2015-0097415

(51) Int. Cl. G06F 3/0484; G06F 3/0481

(52) U.S. Cl. CPC G06F 3/04845; G06F 3/04817; G06F 3/04842

(57) ABSTRACT

An electronic device and a method for changing an icon in the electronic device are provided. The electronic device includes a display, and a controller configured to control display of a first icon for execution of a first application on the display, and change of the first icon based on information provided by a second application different from the first application.

### CLAIM OF PRIORITY

This application claims the benefit under 35 U.S.C. §119(a) of a Korean patent application filed in the Korean Intellectual Property Office on Jul. 8, 2015 and assigned Serial No. 10-2015-0097415, the entire disclosure of which is incorporated herein by reference.

### TECHNICAL FIELD

The present disclosure relates to an electronic device, and a method for changing an icon in the electronic device.

### BACKGROUND

Electronic devices have become increasingly sophisticated. However, as electronic devices become more sophisticated, it becomes important that the electronic devices are easy to use. If the devices are difficult to use, the increased sophistication is not properly utilized. Accordingly, user-friendliness becomes increasingly important as devices become more sophisticated.

The above information is presented as background information only to assist with an understanding of the present disclosure. No determination has been made, and no assertion is made, as to whether any of the above might be applicable as prior art with regard to the present disclosure.

### SUMMARY

An aspect of the present disclosure is to address at least the above-mentioned problems and/or disadvantages and to provide at least the advantages described below. Accordingly, an aspect of the present disclosure is to provide an electronic device for changing an icon representing a first application, displayed on a screen using change information acquired from a second application different from the first application, and a method for changing an icon in the electronic device.

In accordance with an aspect of the present disclosure, there is provided an electronic device. The electronic device includes a display, a processor electrically connected to the display, and a memory electrically connected to the processor. The memory stores instructions for, when the instructions are executed, causing the processor to display a first icon configured for user selection of a first application or function on the display, to provide the first application or function with content data related to a change which has occurred to a second application or function different from the first application or function, and to change at least a part of the content data and display the changed content data overlapped with at least a part of the first icon or in the vicinity of the first icon.

In accordance with another aspect of the present disclosure, there is provided an electronic device. The electronic device includes a display, and a controller configured to control display of a first icon for execution of a first application on the display, and change of the first icon based on information provided by a second application different from the first application.

In accordance with another aspect of the present disclosure, there is provided a method for changing an icon in an electronic device. The method includes displaying a first icon configured for user selection of a first application or function on a display of the electronic device, providing the first application or function with content data related to a change which has occurred to a second application or function different from the first application or function, and changing at least a part of the content data, and displaying the changed content data overlapped with at least a part of the first icon or in the vicinity of the first icon.

In accordance with another aspect of the present disclosure, there is provided a method for changing an icon in an electronic device. The method includes displaying a first icon for execution of a first application, changing the first icon based on information provided by a second application different from the first application, and displaying the changed first icon.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features and advantages of certain exemplary embodiments of the present disclosure will be more apparent from the following description taken in conjunction with the accompanying drawings, in which:

FIG. 1 is a block diagram illustrating a network environment according to various embodiments of the present disclosure;

FIG. 2 is a block diagram illustrating a configuration of an electronic device according to various embodiments of the present disclosure;

FIG. 3 illustrates the operation of an electronic device according to various embodiments of the present disclosure;

FIG. 4 illustrates a theme package according to various embodiments of the present disclosure;

FIG. 5 is a flowchart illustrating an operation procedure for changing an icon in an electronic device according to various embodiments of the present disclosure;

FIG. 6 illustrates a theme package according to various embodiments of the present disclosure;

FIG. 7 is a flowchart illustrating an operation procedure for changing an icon in an electronic device according to various embodiments of the present disclosure;

FIG. 8 illustrates tables for changing an icon in an electronic device according to various embodiments of the present disclosure;

FIG. 9A, FIG. 9B and FIG. 9C illustrate graphical user interfaces for changing an icon in an electronic device according to various embodiments of the present disclosure;

FIG. 10A, FIG. 10B and FIG. 10C illustrate graphical user interfaces for changing an icon in an electronic device according to various embodiments of the present disclosure;

FIG. 11 is a flowchart illustrating an operation for changing an icon in an electronic device according to various embodiments of the present disclosure;

FIG. 12 illustrates tables for changing an icon in an electronic device according to various embodiments of the present disclosure;

FIG. 13A and FIG. 13B illustrate graphical user interfaces for changing an icon in an electronic device according to various embodiments of the present disclosure;

FIG. 14A and FIG. 14B illustrate graphical user interfaces for changing an icon in an electronic device according to various embodiments of the present disclosure;

FIG. 15A and FIG. 15B illustrate graphical user interfaces for changing an icon in an electronic device according to various embodiments of the present disclosure;

FIG. 16A and FIG. 16B illustrate exemplary icons displayed in an electronic device according to various embodiments of the present disclosure;

FIG. 17A, FIG. 17B and FIG. 17C illustrate graphical user interfaces for changing an icon in an electronic device according to various embodiments of the present disclosure;

FIG. 18A, FIG. 18B and FIG. 18C illustrate graphical user interfaces for changing an icon in an electronic device according to various embodiments of the present disclosure;

FIG. 19A and FIG. 19B illustrate graphical user interfaces for changing an icon in an electronic device according to various embodiments of the present disclosure;

FIG. 20A and FIG. 20B illustrate graphical user interfaces for changing an icon in an electronic device according to various embodiments of the present disclosure;

FIG. 21A and FIG. 21B illustrate graphical user interfaces for changing an icon in an electronic device according to various embodiments of the present disclosure;

FIG. 22 is a block diagram illustrating an electronic device according to various embodiments; and

FIG. 23 is a block diagram illustrating a programming module according to various embodiments.

Throughout the drawings, like reference numerals will be understood to refer to like parts, components, and structures.

### DETAILED DESCRIPTION

Various embodiments of the present disclosure are described with reference to the accompanying drawings. However, the scope of the present disclosure is not intended to be limited to the particular embodiments and it is to be understood that the present disclosure covers all modifications, equivalents, and/or alternatives falling within the scope and spirit of the present disclosure. In relation to a description of the drawings, like reference numerals denote the same components.

In the present disclosure, the term ‘have’, ‘may have’, ‘include’, or ‘may include’ signifies the presence of a specific feature (for example, number, function, operation, or component such as part), not excluding the presence of one or more other features.

In present disclosure, the term ‘A or B’, ‘at least one of A or/and B’, or ‘one or more of A or/and B’ may cover all possible combinations of enumerated items. For example, ‘A or B’, ‘at least one of A and B’, or ‘at least one of A or B’ may represent all of the cases of (1) inclusion of at least one A, (2) inclusion of at least one B, and (3) inclusion of at least one A and at least one B.

The term as used in the present disclosure, ‘first’ or ‘second’ may modify the names of various components irrespective of sequence and/or importance, not limiting the components. These expressions are used to distinguish one component from another component. For example, a first user equipment (UE) and a second UE may indicate different UEs irrespective of sequence or importance. For example, a first component may be referred to as a second component and vice versa without departing the scope of the present disclosure.

When it is said that a component (for example, a first component) is ‘operatively or communicatively coupled with/to’ or ‘connected to’ another component (for example, a second component), it should be understood that the one component is connected to the other component directly or through any other component (for example, a third component). On the other hand, when it is said that a component (for example, a first component) is ‘directly connected to’ or ‘directly coupled to’ another component (for example, a second component), it may be understood that there is no other component (for example, a third component) between the components. Additionally, wirelessly connected shall be understood to include devices sharing a point-to-point radio channel.

The term ‘configured to’ may shall mean ‘specifically designed to’ in hardware, hardware storing software or firmware, or a combination of both. The term ‘capable of’ as used herein may be replaced with, for example, the term ‘suitable for’ having the capacity to', ‘designed to’, ‘adapted to’, ‘made to’, or ‘capable of’ under circumstances. Instead, the term ‘capable of’ may mean that a device may mean ‘capable of’ with another device or part. For example, ‘a processor capable of executing A, B, and C’ may mean a dedicated processor (for example, an embedded processor) for performing the corresponding operations or a generic-purpose processor (for example, a central processing unit (CPU) or an application processor (AP)) for performing the operations.

The terms as used in the present disclosure are provided to describe merely specific embodiments, not intended to limit the scope of other embodiments. It is to be understood that singular forms include plural referents unless the context clearly dictates otherwise. Unless otherwise defined, the terms and words including technical or scientific terms used in the following description and claims may have the same meanings as generally understood by those skilled in the art. The terms as generally defined in dictionaries may be interpreted as having the same or similar meanings as or to contextual meanings of related technology. Unless otherwise defined, the terms should not be interpreted as ideally or excessively formal meanings. When needed, even the terms as defined in the present disclosure may not be interpreted as excluding embodiments of the present disclosure.

An electronic device according to various embodiments of the present disclosure may be at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical equipment, a camera, or a wearable device. According to various embodiments, the wearable device may be at least one of an accessory type (for example, a watch, a ring, a bracelet, an ankle bracelet, a necklace, glasses, a contact lens, or a head-mounted device (HMD)), a fabric or clothes type (for example, electronic clothes), a body-attached type (for example, a skin pad or a tattoo), or an implantable type (for example, an implantable circuit).

According to some embodiments, an electronic device may be a home appliance. For example, the home appliance may be at least one of, for example, a television (TV), a digital versatile disk (DVD) player, an audio player, a refrigerator, an air conditioner, a vacuum cleaner, an oven, a microwave oven, a washer, an air purifier, a set-top box, a home automation control panel, a security control panel, a TV box (for example, Samsung HomeSync™, Apple TV™, Google TV™, or the like), a game console (for example, Xbox™, PlayStation™, or the like), an electronic dictionary, an electronic key, a camcorder, or an electronic picture frame.

According to other embodiments, an electronic device may be at least one of a medical device (for example, a portable medical meter such as a blood glucose meter, a heart rate meter, a blood pressure meter, or a body temperature meter, a magnetic resonance angiography (MRA) device, a magnetic resonance imaging (MRI) device, a computed tomography (CT) device, an imaging device, an ultrasonic device, or the like), a navigation device, a global navigation satellite system (GNSS), an event data recorder (EDR), a flight data recorder (FDR), an automotive infotainment device, a naval electronic device (for example, a naval navigation device, a gyrocompass, or the like), an avionic electronic device, a security device, an in-vehicle head unit, an industrial or consumer robot, an automatic teller machine (ATM) in a financial facility, a point of sales (POS) device in a shop, or an Internet of things (IoT) device (for example, a lighting bulb, various sensors, an electricity or gas meter, a sprinkler, a fire alarm, a thermostat, a street lamp, a toaster, sports goods, a hot water tank, a heater, or a boiler).

According to some embodiments, an electronic device may be at least one of furniture, part of a building/structure, an electronic board, an electronic signature receiving device, a projector, and various measuring devices (for example, water, electricity, gas or electro-magnetic wave measuring devices). According to various embodiments, an electronic device may be one or a combination of two or more of the foregoing devices. According to some embodiments, an electronic device may be a flexible electronic device. In addition, it will be apparent to one having ordinary skill in the art that an electronic device according to an embodiment of the present disclosure is not limited to the foregoing devices and covers a new electronic device produced along with technology development.

With reference to the attached drawings, an electronic device according to various embodiments will be described below. In the present disclosure, the term ‘user’ may refer to a person or device (for example, artificial intelligence electronic device) that uses an electronic device.

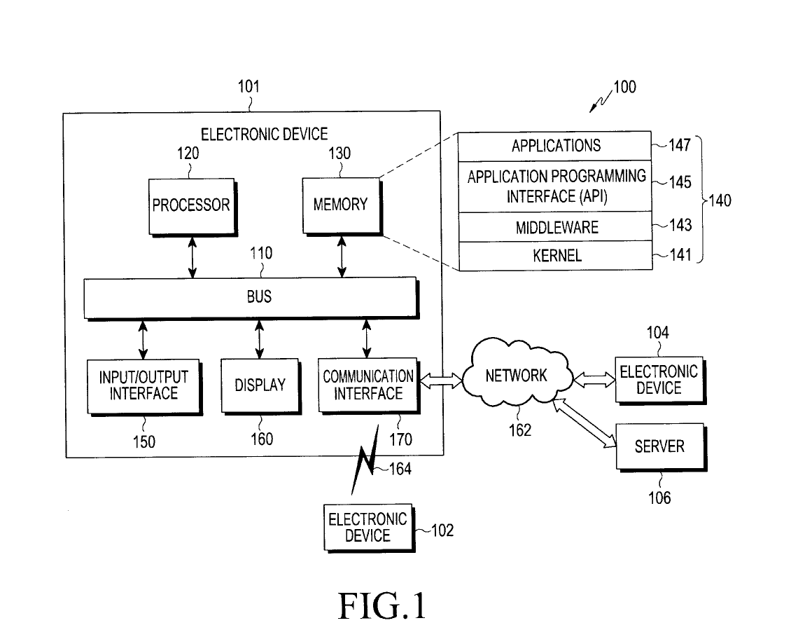

Referring to FIG. 1, an electronic device 101 in a network environment 100 according to various embodiments is described. The electronic device 101 may include a bus 110, a processor 120, a memory 130, an input/output (I/O) interface 150, a display 160, and a communication interface 170. In some embodiments, at least one of the components may be omitted in the electronic device 101 or a component may be added to the electronic device 101.

The bus 110 may include a circuit that interconnects, for example, the foregoing components 120, 130, 150, 160, and 170 and allows communication (for example, control messages and/or data) between the foregoing components.

The processor 120 may include one or more of a CPU, an AP, or a communication processor (CP). The processor 120 may, for example, execute computation or data processing related to control and/or communication of at least one other component of the electronic device 101.

The memory 130 may include a volatile memory and/or a non-volatile memory. The memory 130 may, for example, store instructions or data related to at least one other component. According to an embodiment, the memory 130 may store software and/or programs 140. The programs 140 may include, for example, a kernel 141, middleware 143, an application programming interface (API) 145, and/or application programs (or applications) 147. At least a part of the kernel 141, the middleware 143, and the API 145 may be called an operating system (OS).

The kernel 141 may control or manage system resources (for example, the bus 110, the processor 120, or the memory 130) that are used in executing operations or functions implemented in other programs such as the middleware 143, the API 145, or the application programs 147. Also, the kernel 141 may provide an interface for allowing the middleware 143, the API 145, or the application programs 147 to access individual components of the electronic device 101 and control or manage system resources.

The middleware 143 may serve as a medium through which the kernel 141 may communicate with, for example, the API 145 or the application programs 147 to transmit and receive data.

Also, the middleware 143 may process one or more task requests received from the application programs 147 according to their priority levels. For example, the middleware 143 may assign priority levels for using system resources (the bus 110, the processor 120, or the memory 130) of the electronic device 101 to at least one of the application programs 147. For example, the middleware 143 may perform scheduling or load balancing for the one or more task requests by processing the one or more task requests according to the priority levels assigned to the at least one application program 147.

The API 145 is an interface that may control functions that the application programs 147 provide at the kernel 141 or the middleware 143. For example, the API 145 may include at least one interface or function (for example, a command) for file control, window control, video processing, or text control.

The I/O interface 150 may, for example, act as an interface that provides a command or data received from a user or an external device to the other component(s) of the electronic device 101. Further, the I/O interface 150 may output a command or data received from the other component(s) to the user or the external device.

The display 160 may include, for example, a liquid crystal display (LCD), a light emitting diode (LED) display, an organic LED (OLED) display, a microelectromechanical systems (MEMS) display, or an electronic paper display. The display 160 may display, for example, various types of content (for example, text, an image, a video, an icon, or a symbol) to the user. The display 160 may include a touch screen and receive, for example, a touch input, a gesture input, a proximity input, or a hovering input through an electronic pen or a user's body part.

The communication interface 170 may establish communication, for example, between the electronic device 101 and an external device (for example, a first external electronic device 102, a second external electronic device 104, or a server 106). For example, the communication interface 170 may be connected to a network 162 by wireless communication or wired communication and communicate with the external device (for example, the second external electronic device 104 or the server 106) over the network 162.

The wireless communication may be conducted using, for example, at least one of long term evolution (LTE), LTE-advanced (LTE-A), code division multiple access (CDMA), wideband CDMA (WCDMA), universal mobile telecommunication system (UMTS), wireless broadband (WiBro), or global system for mobile communications (GSM), as a cellular communication protocol. The wireless communication may include, for example, short-range communication 164. The short-range communication 164 may be conducted by, for example, at least one of wireless fidelity (WiFi), Bluetooth, near field communication (NFC), or GNSS. GNSS may include, for example, at least one of global positioning system (GPS), global navigation satellite system (Glonass), Beidou navigation satellite system (hereinafter, referred to as ‘Beidou’), or Galileo, the European global satellite-based navigation system, according to a region using the GNSS or a used bandwidth. In the present disclosure, the terms ‘GPS’ and ‘GNSS’ are interchangeably used with each other. The wired communication may be conducted in conformance to, for example, at least one of universal serial bus (USB), high definition multimedia interface (HDMI), recommended standard 232 (RS-232), or plain old telephone service (POTS). The network 162 may be a telecommunication network, for example, at least one of a computer network (for example, local area network (LAN) or wide area network (WAN)), the Internet, or a telephone network.

Each of the first and second external electronic devices 102 and 104 may be of the same type as or a different type from the electronic device 101. According to an embodiment, the server 106 may include a group of one or more servers. According to various embodiments, all or a part of operations performed in the electronic device 101 may be performed in one or more other electronic devices (for example, the electronic devices 102 and 104) or the server 106. According to an embodiment, if the electronic device 101 is to perform a function or a service automatically or upon request, the electronic device 101 may request at least a part of functions related to the function or the service to another device (for example, the electronic device 102 or 104 or the server 106), instead of performing the function or the service autonomously, or additionally. The other electronic device (for example, the electronic device 102 or 104 or the server 106) may execute the requested function or an additional function and provide a result of the function execution to the electronic device 101. The electronic device 101 may provide the requested function or service based on the received result or by additionally processing the received result. For this purpose, for example, cloud computing, distributed computing, or client-server computing may be used.

The electronic device 101 is capable of displaying various types of objects on a screen of a display. The electronic device may download a user-intended theme package related to an object from a content providing device and install the downloaded theme package. A content provider, such as server 106 may create and distribute the theme package by means of a theme creation tool, and the theme package may include resources and parameter information for configuring a graphical user interface (GUI) on an application basis.

Further, the electronic device 101 may configure a GUI to be displayed on a screen, for example, display a home screen, a font, a background screen, an icon, or a color according to a user's preferences using the installed theme package.

The electronic device may apply a user-intended theme by displaying an object on a screen using resources included in the theme package, the object may be displayed or changed not only using information (resource information) configured in relation to an application or function corresponding to the object, but with other information.

Objects displayed on the screen may display not only information (resource information) related to their corresponding applications, but other information as well. Therefore, if the electronic device is to check information about another application or function related to an application corresponding to an object displayed on the screen, the electronic device can select a specific menu or option and check the intended information by executing the application or function, or additionally configure information under circumstances.

The term ‘theme’ as used in various embodiments of the present disclosure means a graphical appearance details comprising a set of shapes and colors for graphical control elements, generally customizing the look and feel of a user interface (UI) displayed on a screen of an electronic device. Themes are often used to change the look and feel of a wide range of things at once, which makes them much less granular than allowing the user to set each option individually. The term ‘theme package’ may refer to a discrete software set developed by a developer, including data related to at least one theme. A UI may be displayed on a screen of the electronic device, by means of at least one of a home screen, a font, a color, a background screen, an icon (including a widget icon), a wallpaper, and the like.

Icons as described in various embodiments of the present disclosure may be displayed on a screen of the electronic device, in forms easily perceivable to a user, for example, in the form of a picture, an image, a photo, a figure, or a symbol so that the user may easily select various types of programs (including application programs), commands, or functions, which are executable in the electronic device. Icons may also represent and allow the user to select a data (information) file, resulting in execution of an associated program, command or function in conjunction with the data file. For example the program may be a word processing program. Further, the icons may be displayed in a view area defined for information control on a part of a display screen, and may function to indicate operations related to various types of programs (including application programs), commands, functions, or data (information) files through UIs.

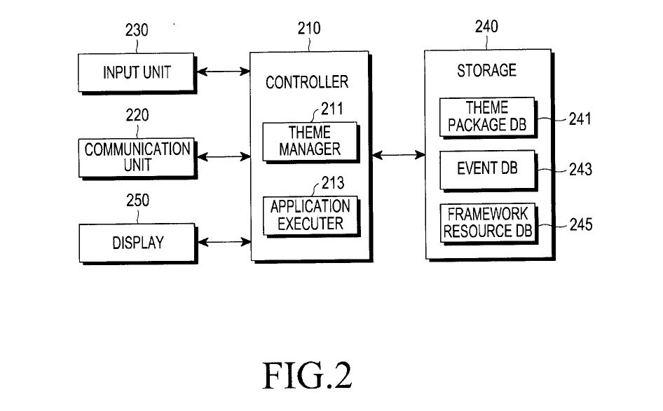

FIG. 2 is a block diagram illustrating an exemplary configuration of an electronic device according to various embodiments of the present disclosure.

Referring to FIG. 2, according to various embodiments of the present disclosure, an electronic device (for example, the electronic device 101) may include at least one of a controller 210, a communication unit 220, an input unit 230, a storage 240, or a display 250.

According to various embodiments of the present disclosure, the controller 210 (for example, the processor 120 illustrated in FIG. 1) may process information along with operation of the electronic device and information along with execution of a program, an application, or a function. The controller 210 may control display of the processed information on the display 250 or output of the processed information through an audio module (not shown).

According to various embodiments of the present disclosure, the controller 210 may control display of one or more objects of various forms on a screen of the display 250, which are related to various types of programs (including application programs), commands, functions, or data (information) files included in the electronic device or another electronic device interworking with the electronic device. The following description will be given with the appreciation that the one or more objects are icons by way of example, in various embodiments of the present disclosure.

According to various embodiments, the controller 210 may control display of icons representing various types of programs (including application programs), commands, functions, or data (information) files included in the electronic device or another electronic device interworking with the electronic device, on a part or predetermined area of a screen of the display 250.

According to various embodiments of the present disclosure, the controller 210 may be configured to include at least one of a theme manager 211 or an application executer 213 and to further include various other components according to operations of the electronic device.

The theme manager 211 may receive, from an external device (for example, at least one of the server 106 or the external electronic device 102 or 104), a theme package (for example, content). The theme manager 211 may use the theme package to configure a theme for at least one object displayed on a screen of the display 250, and install and manage the received theme package. According to various embodiments, the theme manager 211 of the controller 210 may select at least one object identified by the theme data. The theme manager 211 may then apply the theme data that identifies the at least one object to an application or module (or function) corresponding to the identified at least one object.

According to various embodiments, the theme data may identify an icon. The theme manager 211 may use an icon resource according to theme data identifying the icon to control display of an icon image on a predetermined area of the display 250. An icon can be associated with a target application or application module. The theme data can include theme event data. The theme manager 211 may determine the target application or application module associated with the icon to be changed, based on theme event data, that is, information for icon change (for example, information about the target application or module and change condition information). The theme manager 211 may transmit the change condition information to the determined target application or module (or function). Also, the theme manager 211 may receive identification information from the application executer 213. The identification information can be about the target application or module together with change information. The change information can be based on a change condition from the target application or module. The application executor 213 can change an icon resource based on the received information. The icon resource may be stored in a theme package database (DB) of the storage 240 and changed according to the change information. The theme manager 211 may control display of a changed icon image on the display 250 by transmitting the icon image re-configured by the changed icon resource to the application executer 213.

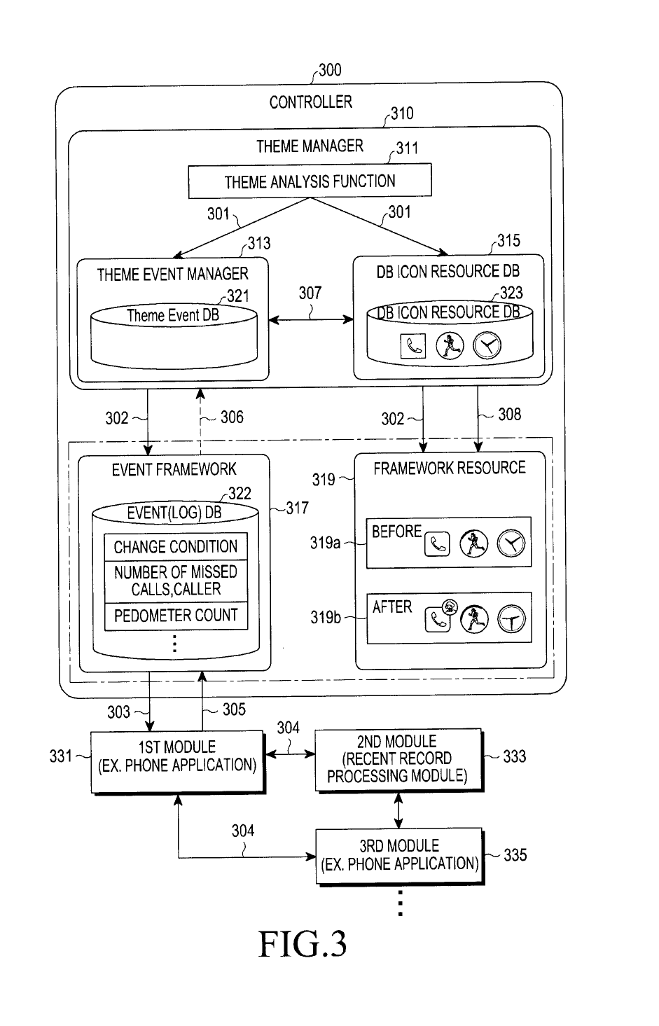

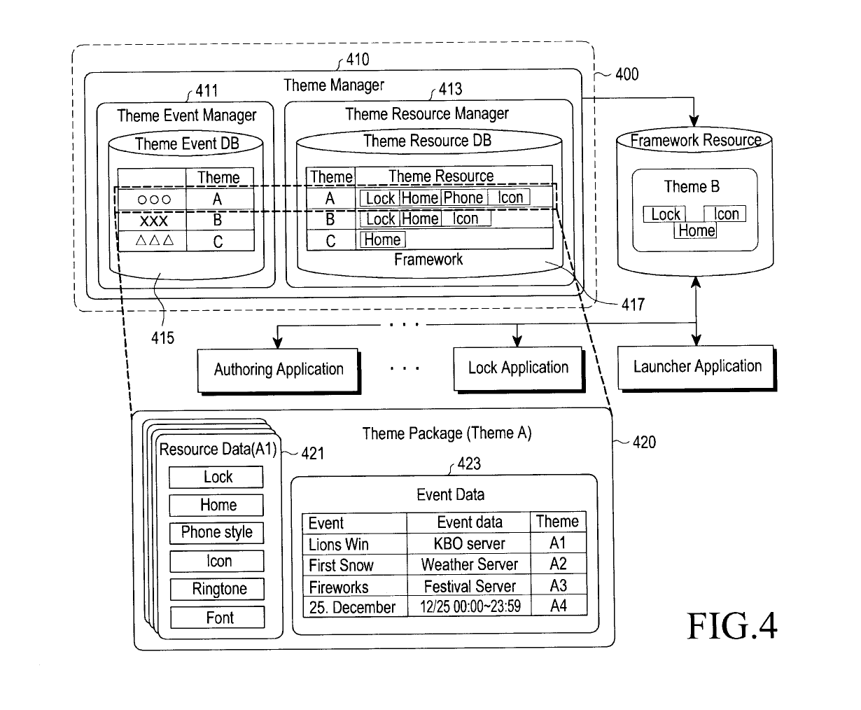

According to various embodiments, the theme manager 211 may be configured to include a component for analyzing a theme package, a component (for example, a theme event manager) for managing theme event data stored in the theme event DB of the storage 240, or a component (for example, a theme resource manager) for managing a theme resource stored in the theme resource DB of the storage 240. A specific operation of the above theme manager 211 will be described in detail with reference to FIGS. 3 and 4.

According to various embodiments, the application executer 213 may manage and execute an application in conjunction with other programs or functions included in the electronic device. The application executer 213 may register a change condition information received from the theme manager 211. The application executor 213 registers the change condition by transmitting the change condition information to the target application or application module. Further, the application executer 213 may collect information from the target application or application module. The information is according to the change condition. The application executor 213 may also acquire change information by determining whether the collected information satisfies the change condition. The application executor 213 can then transmit the acquired change information to the theme manager 211 so that the change information may be applied to the icon resource. The application executer 213 may also receive the changed icon resource of the target application among the theme resource data stored in the theme package DB 241 of the storage 240 and control display of an icon image representing the target application.

When an event specified by the change condition occurs, the controller 210 may collect or cause collection of change information related to the change condition. The controller 210 may periodically collect or cause periodic collection of information and extraction of information satisfying the change condition as change information.

According to various embodiments of the present disclosure, the controller 210 may collect change information satisfying a change condition for an icon displayed on a screen. The controller 210 may collect the change information from at least one of a hardware module or a software module in the electronic device or an external electronic device. According to various embodiments, the controller 210 may be a hardware module or a hardware module including memory storing instructions (for example, an application program). The controller 210 may be a hardware component (function) or memory storing instructions (program), which interacts with at least one of various sensors, a data measurement module, an Input/Output (I/O) interface, a module for managing states or environments of the electronic device, or a communication module, which is provided in the electronic device.

When user input for an icon that is configured with a changed icon resource and displayed after the icon resource is changed (using change information based on a change condition), the controller 210 may execute/cause execution of a target application (or function) represented by the icon in correspondence with the received user input information. According to various embodiments, upon receipt of a specific user input for the changed icon, the controller 210 may control change of the changed icon in correspondence with the specific user input and display of the re-changed icon in a corresponding area of a screen of the display 250.

The controller 210 may change/cause change of at least one of the display area size, shape, color, transparency, or display position of at least one object (for example, icon) indicated by the change condition. The controller 210 can then display/cause display of the changed object on a screen of the display 250. Also, the controller 210 may display/cause display of information added according to a change condition that is overlapped with the at least one object (for example, icon).

The controller 210 of the electronic device may be at least a part of a processor, for example, one or a combination of hardware, and memory storing software or firmware. According to various embodiments, the controller 210 may be configured to be without at least a part of the foregoing components or to further include a component for performing an image processing operation in addition to the foregoing components.

At least a part of the configuration of the controller 210 of the electronic device may include, in hardware, a part of at least one processor including a central processing unit (CPU)/micro processing unit (MPU), at least one memory (for example, a register and/or a random access memory (RAM)) for loading memory loading data, and a bus for inputting/outputting at least one data from/to the processor and the memory. Further, the controller 210 may be configured to include, in software, a predetermined program routine or program data, which is loaded from a predetermined recording medium to a memory and computed and processed by the processor in order to execute functions defined in the electronic device.

The communication unit 220 (for example, the communication interface 170 illustrated in FIG. 1) of the electronic device may communicate with another electronic device or an external device under the control of the controller 210. According to various embodiments, the communication unit 220 may transmit and receive data related to an operation performed under the control of the controller 210 to and from an external device. The communication unit 220 may communicate via a connection to a network or a device-to-device connection by wireless or wired communication through a communication interface. The wireless communication may be conducted using, for example, at least one of WiFi, Bluetooth (BT), near field communication (NFC), global positioning system (GPS), or cellular communication (for example, long term evolution (LTE), LTE-advanced (LTE-A), code division multiple access (CDMA), wideband CDMA (WCDMA), universal mobile telecommunication system (UMTS), wireless broadband (WiBro), or global system for mobile communications (GSM)). The wired communication may be conducted in conformance to, for example, at least one of universal serial bus (USB), high definition multimedia interface (HDMI), recommended standard 232 (RS-232), or plain old telephone service (POTS). Further, besides the above communication schemes, the communication unit 220 may operate according to any other communication scheme which is widely known or will be developed in the future.

The input unit 230 (for example, the I/O interface 150 illustrated in FIG. 1) of the electronic device may transmit, to the controller 210, an input signal related to various information, various function settings, and control of functions of the electronic device among digit information and text information received from a user. Also, the input unit 230 may support a user input for executing a module or application supporting a specific function. The input unit 230 may include at least one of a key input means such as a keyboard or a keypad, a touch input means such as a touch sensor or a touch pad, a virtual keyboard, a sound source input means, a camera, or various sensors, and may include a gesture input means. Besides, the input unit 230 may include any other type of input means which is being or will be developed. According to various embodiments of the present disclosure, the input unit 230 may receive user-input information through a touch panel or a camera from the user and provide the input information to the controller 210.

The input unit 230 may transmit information about a user's gesture received through a camera or various sensors to the controller 210. Further, the input unit 230 may transmit an input signal related to at least one object (for example, icon) displayed on a screen. Also, the input unit 230 may transmit, as change information, information received through a target application or module (or function) according to a change condition to the controller 210.

The storage 240 (for example, the memory 130 illustrated in FIG. 1) of the electronic device 240 may store programs required for executing functions according to various embodiments and temporarily store various data generated during program execution. The storage 240 may largely include a program area and a data area. The program area may store information related to driving of the electronic device, such as an OS for booting the electronic device. The data area may store transmission data or received data, and generated data according to various embodiments. The storage 240 may be configured to include at least one of the storage media of a flash memory, a hard disk, a multimedia card, a micro-type memory (for example, a secure digital (SD) or extreme digital (XD) memory), a RAM, and a read only memory (ROM).

The storage 240 may include a DB for storing information related to at least one object displayed on a partial area of a screen. The storage 240 may include at least one of the theme package DB 241, an event DB 243, or a framework resource DB 245. The theme package DB 241 may store information related to a theme package received from a server. The information related to the theme package may include theme event data or theme resource data (for example, icon resource data), which is acquired by analyzing the theme package. The event DB 243 may store, as event (or log) information, change information acquired from an application or module other than a target application or module in the electronic device or another electronic device according to a change condition. The framework resource DB 245 may store resources for various applications being executed in the electronic device, for example, a resource of an application or module corresponding to an icon displayed on a screen.

The display 250 (for example, a part of the components of the I/O interface 150 or the display 160 in FIG. 1) may output information (for example, at least one of text, an image, or a video) resulting from execution of an operation under the control of the controller 210.

The display 250 may display an input pad (for example, a button) for inputting at least one of various characters, digits, or symbols in an input window, on a screen in various manners. The display 250 may also display service execution screens along with execution of various applications related to information transmission and reception. The display 150 may display at least one object (for example, icon) in a defined display area of a screen. Display of the at least one object may be according to theme data included in a theme package. The display 250 may display an icon that is changed by change information. The change information may be generated according to a change condition in the display area or a different area, under the control of the controller 210. Further, the display 250 may display the icon re-changed according to a user input under the control of the controller 210.

If the display 250 of the electronic device is configured as a touch screen, the display 250 may correspond to a touch screen of an input unit (not shown). If the display 250 is configured together with the input unit 230, as a touch screen, the display 250 may display various types of information generated according to a user's touch.

The display 250 may be at least one of a liquid crystal display (LCD), a thin film transistor LCD (TFT-LCD), an organic light emitting diode (OLED) display, a light emitting diode (LED) display, active matrix organic LED (AMOLED) display, a flexible display, and a three-dimensional (3D) display. A part of these displays may be configured to be transparent or light-transmissive so that the outside may be viewed through the display. The display 250 may be configured as a transparent display including a transparent OLED (TOLED).

The electronic device may further include a display (for example, an extended display or a flexible display) other than the display 250, or a display of an external electronic device (for example, an external display device, a wearable device, or an external terminal) interworking with the electronic device.

The electronic device may include an audio module (not shown) (for example, the I/O interface 150 illustrated in FIG. 1). The audio module may output sound and may be configured to include, for example, at least one of an audio codec, a microphone (MIC), a receiver, an earphone output (EAR_L), or a speaker. According to various embodiments of the present disclosure, the electronic device may further include a means for outputting vibrations or a means for outputting smell.

Main components of the electronic device have been described above with reference to FIG. 2. However, it is to be understood that all of the components illustrated in FIG. 2 are not mandatory, and the electronic device may be configured to include more components or fewer components than illustrated in FIG. 2. Also, the positions of the main components of the electronic device described with reference to FIG. 2 may be changed according to various embodiments.

An electronic device may include a display, a processor electrically connected to the display, and a memory electrically connected to the processor. The memory may store instructions for, when the instructions are executed, enabling the processor to display a first icon configured for a user to select a first application or function on the display, to provide the first application or function with content data related to a change occurring to a second application or function different from the first application or function, and to contract or change at least a part of the content data and display the contracted or changed content data overlapped partially with the first icon or in the vicinity of the first icon on the display.

The content data may include at least one of a picture, an image symbol, or text.

The instructions may enable the processor to acquire, from an external device, the first icon, and format information and condition information for displaying at least one content data overlapped partially with the first icon or in the vicinity of the first icon.

The instructions may enable the processor to change the at least partially contracted or changed content data by determining according to a change condition whether at least one piece of state information related to the electronic device or an external electronic device connected to the electronic device satisfies a selected condition.

The change condition or state information may include information related to at least one of call termination, message reception, weather, temperature, a current time, a use time, a biometric state of a user, or a user input.

The external electronic device may be at least one of a server or a companion device of the electronic device.

An electronic device may include a display, and a controller configured to control display of a first icon for execution of a first application and change of the first icon using information provided by a second application different from the first application.

The controller may control display of the first icon using an icon resource included in a theme package installed in the electronic device and display of the first icon representing the first application, changed by information acquired from the second application related to a change condition included in the theme package, according to the change condition.

The controller may control storing of the theme package separately as event data and resource data and display of the first icon by applying an icon resource included in the received theme package to the first application.

The second application may be a program or module included in the electronic device or an external electronic device.

The theme package may include event data including at least one of information about a change condition for changing the first icon, identification information about the first application, and an icon resource for the first application.

Upon generation of a user input for an image of the first icon after the first icon is changed, the controller may control display of the changed first icon along with additional information configured by applying information acquired from the second application according to the user input.

The controller may control display of the first icon changed in at least one of shape, color, animation effect, icon frame, icon display state, or icon position according to at least one of time, weather, interested content, a position, or an application use frequency based on information provided by the second application.

The controller may control change of all icons displayed on a screen including the first icon by applying the change information uniformly to the first icon and the other icons displayed on the screen based on information provided by the second application, and display of the changed icons on the screen.

FIG. 3 illustrates operation of an electronic device according to various embodiments of the present disclosure.

Referring to FIG. 3, according to various embodiments of the present disclosure, an electronic device (for example, the electronic device 101 illustrated in FIG. 1) may request a theme search to an external electronic device. The external electronic device manages a theme created by a content provider (for example, the electronic device 102 or 104 or the server 106 in FIG. 1). The electronic device 101 can download a theme package from the external electronic device, and manage the downloaded theme package. According to various embodiments, the theme package may be created and distributed in a file format (for example, android application package (APK)) configured by the content provider. The file format may include resources and parameter information in the form of assets, which are required for configuring a GUI on an application basis.

According to various embodiments, as illustrated in FIG. 3, a theme manager 310 (for example, the theme manager 211 of the controller 210 in FIG. 2) included in a controller 300 of the electronic device (for example, the controller 210 in FIG. 2) may divide the downloaded theme package into theme event data and theme resource data by analyzing the theme package through a theme analysis function 311.

In operation 301, the theme manager 310 may store the theme event data in a theme event DB 321 of a theme package DB (or example, the theme package DB 341 in FIG. 2) through a theme event manager 313. The theme manager 310 may also store the theme resource data in a theme resource DB 323 of the theme package DB (for example, the theme package DB 241 in FIG. 2) through a theme resource manager 315.

In operation 302, the theme event manager 313 of the theme manager 310 may provide information about a target module or application (for example, a first module 331) and information about a change condition for the target module or application, which are included in the theme event data, to an event framework 317 included in a framework. The event framework 317 may store and manage the information received from the theme event manager 313 in an event DB 322 (for example, the event DB 243 in FIG. 2). The framework supports necessities for developing application programs running on an OS. For example, the framework may provide information (a frame) required for configuring at least one object (for example, icon) based on a GUI displayed on a screen of the electronic device. The event framework 317 may provide the theme event data, that is, information received from the target module or application according to the change condition, as information for configuring an icon.

In operation 303, the event framework 317 may provide the received information about the change condition to the first module (or application) 331 identified by the information about the target module or application. The first module 331 may provide the received change condition information to another module identified based on the received change condition information, another module which has been set, or every other module interworking with the first module, that is, a second module 333 or a third module 335, so that the second module 333 or the third module 335 may register the change condition information.

In operation 304, the first module 331 may collect information from the second module 333 or the third module 335 and determine whether the collected information is change information generated according to the change condition information.

In operation 305, the first module 331 may provide the determined change information along with information about the target module to the event framework 317.

In operation 306, the event framework 317 may store and manage the received change information in the event DB 322 and may provide the received change information to the theme event manager 313.

In operation 307, the theme event manager 313 may provide the change information to the theme resource manager 315. In operation 308, the theme resource manager 315 may apply the change information received from the theme event manager 313 to a framework resource 319. According to various embodiments, the theme resource manager 315 may change a previous theme resource (for example, icon resource) 319a using the change information. Therefore, the framework resource 319 may include, for example, the previous theme resource (for example, the previous icon resource) 319a and a theme resource (for example, a changed icon resource) 319b changed by applying the change information. The theme manager 310 may read the changed theme resource 319b for configuring an icon displayed on a screen of the display, from the framework resource 319, and provide the changed theme resource 319b to an application executer (for example, the application executer 213 in FIG. 2) of the controller 300. The application executer may configure a new icon (for example, icon image) based on the changed theme resource 319b and display the new icon by replacing an existing icon with the new icon.

FIG. 4 illustrates an exemplary theme package according to various embodiments of the present disclosure.

Referring to FIG. 4, according to various embodiments, a theme event manager 411 of a theme manager 410 in a controller 400 (for example, the theme manager 211 of the controller 210 in FIG. 2) may store theme event data separated from a theme package in a theme event DB 415 included in a storage (for example, the theme package DB 241 of the storage 240 in FIG. 2). A theme resource manager 413 of the theme manager 410 may store theme resource data in a theme resource DB 417 included in the storage (for example, the theme package DB 241 of the storage 240 in FIG. 2). Further, the theme package may include resource data Al 421 and event data 423 which are related to at least one object displayed on a screen, for example, theme A 420. The resource data 421 may include resource data for at least one of theme GUIs, for example, a lock screen, a home screen, a phone style, an icon, a ringtone, or a font. The theme package may be configured as an extensible markup language (XML) file.

With reference to the attached drawings, a detailed description will be given of an operation procedure for changing at least one object (for example, icon) displayed on a screen of an electronic device according to various embodiments of the present disclosure based on the operation of an electronic device described with reference to FIG. 3 and the theme package described with reference to FIG. 4.

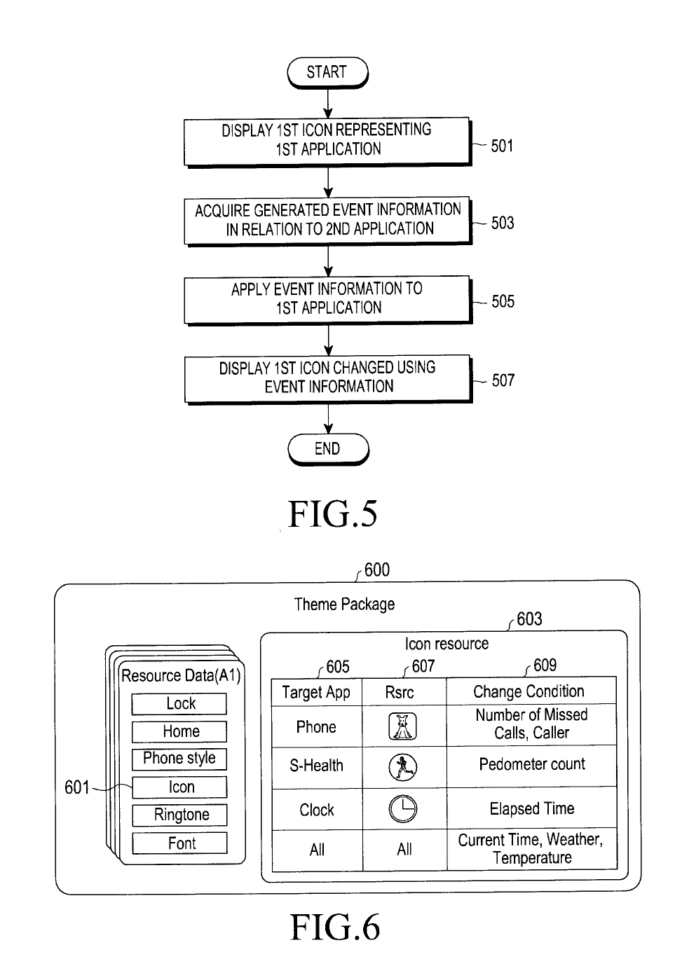

FIG. 5 is a flowchart illustrating an operation procedure for changing an icon in an electronic device according to various embodiments of the present disclosure, and FIG. 6 illustrates an exemplary theme package according to various embodiments of the present disclosure.

Referring to FIG. 5, the electronic device (for example, the electronic device 101 in FIG. 1) according to various embodiments of the present disclosure may identify a target application or module (function) (hereafter, depicted as a first application, by way of example) based on theme data included in a theme package, and display resource data, for example, an icon (hereinafter, referred to as a first icon) for the identified first application in operation 501.

As illustrated in FIG. 6, a theme package 600 may include resource data 601 for a target application or module (for example, a first application) to which a theme will be applied. Resource data 603 for an icon being one of resource data to which the theme will be applied may include at least one of identification information 605 about the target application represented by an icon image, an icon image resource 607, or information 609 about a change condition for changing an icon. For example, if the identification information 605 includes information indicating a phone application as a target application, information about the number of missed calls or information about a caller may be included as the change condition information 609, and data for an icon image representing the phone application may be included in the icon image resource 607.

In operation 503, the electronic device may identify a second application based on the change condition information included in the theme data, and collect information from the identified second application. Also, the electronic device determines whether the collected information satisfies the change condition. If the collected information satisfies the change condition, that is, upon occurrence of an event satisfying the change condition, generated information may be acquired as change information.

In operation 505, the electronic device may apply the acquired change information to the first application. According to various embodiments, the electronic device may change the resource data for the first application, for example, the resource data for the previous icon to changed icon resource data reflecting the change information by applying the change information to the resource data for the first application.

In operation 507, the electronic device may replace the icon representing the first application with the icon changed based on the icon resource data and display the changed icon.

While the operation procedure of FIG. 5 has been described in the context of an icon, by way of example, it may also be applied to other theme GUI-based objects (for example, at least one of a lock screen, a home screen, a phone style, a ringtone, a font, and a color).

A method for changing an icon in an electronic device may include displaying, on a display of the electronic device, a first icon configured to enable a user to select a first application or function, providing the first application or function with content data related to a change which has occurred in relation to a second application (or function different from the first application or function), contracting or changing at least a part of the content data, and displaying, on the display, the at least partially contracted or changed content data overlapped with at least a part of the first icon or in the vicinity of the first icon.

The method may further include displaying the first icon for executing the first application, changing the first icon using information provided by the second application different from the first application, and displaying the changed first icon.

The displaying of the first icon for executing the first application may include displaying the first icon based on an icon resource included in a theme package installed in the electronic device.

The changing of the first icon using information provided by the second application different from the first application may include determining a change condition included in the theme package installed in the electronic device, and changing the first icon using the information acquired from the second application related to the change condition, according to the change condition.

The second application may be a program or module included in the electronic device or an external electronic device.

The theme package may include event data which includes at last one of information about the change condition for changing the first icon, identification information about the first application, and an icon resource for the first application.

The method may further include, upon generation of a user input for the changed first icon after the first icon is changed, acquiring information provided by the second application according to the user input, and controlling display of additional information configured by applying the acquired information, along with the changed first icon.

The displaying of the changed first icon may include changing at least one of a shape, color, animation effect, icon frame, icon display state, or icon position of the first icon according to at least one of time, weather, interested content, a position, or an application use frequency based on the information provided by the second application, and displaying the changed first icon.

The method may further include changing all icons displayed on a screen including the first icon by applying the change information uniformly to the first icon and the other icons displayed on the screen based on the information provided by the second application, and displaying the changed icons.

A description will be given of a more detailed operation procedure for changing an object (for example, an icon) in an electronic device according to the foregoing operation procedure of an electronic device according to various embodiments of the present disclosure described with reference to FIGS. 3, 4, and 5.

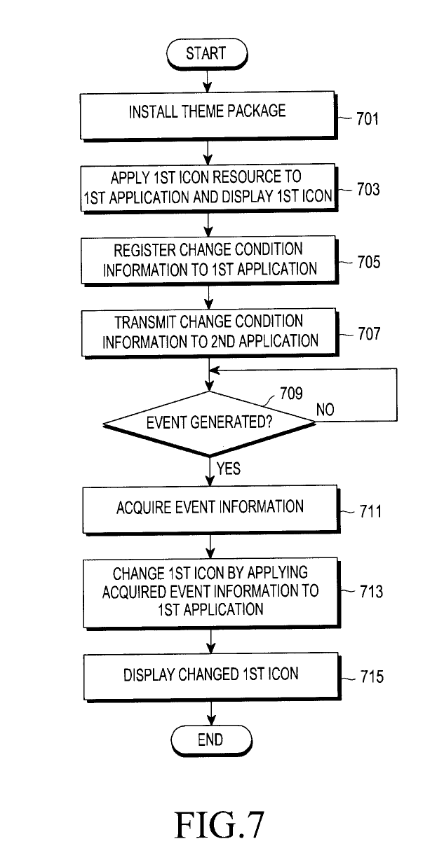

FIG. 7 is a flowchart illustrating an operation procedure for changing an icon in an electronic device according to various embodiments of the present disclosure.

Referring to FIG. 7, the electronic device (for example, the electronic device 101 in FIG. 1) may receive, install, and manage a theme package from an external device (for example, the server 106 or the external electronic device 102 or 104 in FIG. 1), in operation 701. The theme package may be associated with a theme. The theme may be configured for at least one object displayed on a screen

In operation 703, the electronic device may identify at least one object (resource) to which a theme will be applied based on theme data included in the theme package, that is, a target application or module (hereinafter, referred to as a first application) corresponding to the at least one object, and apply theme resource data corresponding to the first application, included in the theme data, to resource data of the first application (for example, the framework resource 319 in FIG. 3). According to various embodiments, the electronic device may apply, as a resource for a first icon representing the first application, icon resource data included in the theme resource data corresponding to the first application, included in the theme package, and display, in an area of a screen, the first icon configured with the first icon resource.

In operation 705, the electronic device may check information about a change condition, for example, the icon resource of the first application and register the checked information about the change condition to the first application.

In operation 707, the electronic device may transmit the checked information about the change condition to at least one other application (for example, a second application) that is related to the first application so that the information about the change condition may be registered to the at least one other application. The electronic device may transmit the information about the change condition to another application which has been set or another application related to the information about the change condition. The application receiving the information about the change condition may be another application included in the electronic device or another electronic device. While another application has been described as an application, for the convenience of description, the application may be a hardware or software component or programming module that performs various functions of the electronic device. The operations described below, and operations according to embodiments of the present disclosure described as performed by another application may be applied in the same manner to the module. Another application or module may be at least one of, for example, one other peripheral device such as various sensors, a network or connector module, or a data measuring module, or one other application program (application) installed in the electronic device or another electronic device.

According to various embodiments, the electronic device may collect information from the other application, periodically or according to a change condition, and acquire information satisfying the change condition out of the collected information, as change information. To acquire the change information, the electronic device may perform operations 709 and 711.

In operation 709, waits until an event is generated. According to various embodiments, if the information collected periodically from the other application satisfies the change condition, the electronic device may determine that an event has occurred. Further, according to various embodiments, if the electronic device has collected information from the other application at a time point based on the change condition, the electronic device may determine that an event has occurred. If the electronic device determines that an event has occurred in operation 709, the electronic device may perform operation 711. On the contrary, if determining that an event has not occurred in operation 709, the electronic device may repeat operation 709 until an event is generated.

In operation 711, upon occurrence of an event, the electronic device may acquire change information from the other application.

In operation 713, the electronic device may change the first icon displayed on the screen by applying the acquired change information to the first application. According to various embodiments, the electronic device may change and manage an icon resource of the first application by applying the acquired change information to the icon resource of the first application.

In operation 715, the electronic device may change the old first icon displayed on the screen to a new first icon configured with the changed icon resource.

While the operation procedure of FIG. 7 has been described in the context of an icon, by way of example, it may also be applied to other theme GUI-based objects (for example, at least one of a lock screen, a home screen, a phone style, a ringtone, a font, and a color).

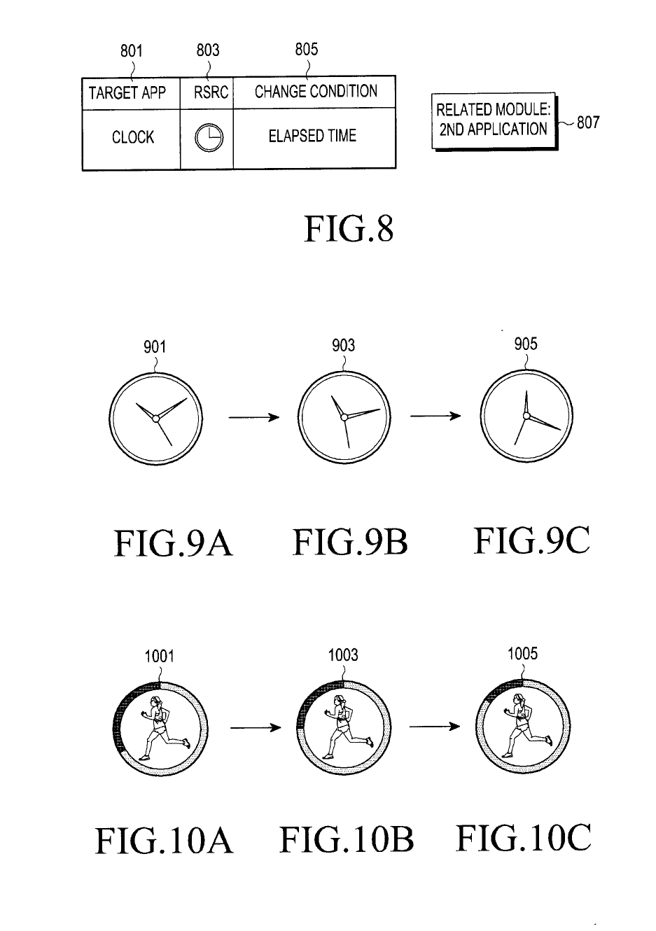

FIGS. 8, 9, and 10 illustrate exemplary objects for changing an icon in an electronic device according to various embodiments of the present disclosure.

Referring to FIG. 8, according to various embodiments, theme data of a theme package may include information (identification information) 801 about a clock application, a clock resource 803, and information 805 about a change condition. In this case, the electronic device may include an elapsed time as the change condition information, and determine that a module related to the change condition, for example, a second application 807.

The electronic device may display an icon image of the clock application on a screen, as illustrated in FIG. 8. In other words, as illustrated in (a) of FIG. 9, the electronic device may display a clock icon image 901 for the first application (for example, the clock application) configured with an icon resource (for example, the icon resource 603 in FIG. 6) included in the installed theme package (for example, the theme package 600 in FIG. 6). The icon image of FIG. 9 may be a clock icon image for a time-related application such as alarm, world time, stopwatch, timer, or the like. The icon image may be displayed changed according to a time condition at an icon displayed time point.

As illustrated in (b) of FIG. 9, the electronic device may change the clock icon image 901 to indicate passage of time. The clock icon image 901 can be changed using an icon image resource. Change information, which has been acquired from the second application (for example, a GPS module or a time measuring module), upon occurrence of an event according to the change condition, is applied to the icon image resource. According to various embodiments, the electronic device may check a time (for example, 10:10) exposed to a user on a home screen and a time (for example, 11:15) at which the clock application icon is to be displayed due to the user's access to the home screen, and display a changed icon image 903 obtained by applying change information for an animation of rotating the clock needles to point from 10:10 to 11:15 to the icon resource.

As illustrated in (c) of FIG. 9, the electronic device may again display a new clock icon 905 indicating passage of time. The new clock icon 905 is generated using a new icon resource to which information changed according to the change condition is applied. The elapsed time information may include, for example, a time point at which a changed time is to be displayed (for example, on an hour basis, when a screen with an icon on it is displayed, or upon receipt of specific user input information), and information for displaying a current time.

Referring to FIG. 10, according to various embodiments of the present disclosure, the electronic device may display, for example, an icon image 1001 representing a health application on a screen based on an icon resource (for example, the icon resource 603 in FIG. 6) included in a theme package (for example, the theme package 600 in FIG. 6) installed in the electronic device.

As illustrated in (a) of FIG. 10, with an icon image representing a health application displayed, the electronic device may receive information about a change condition included in theme data from another module (for example, a pedometer application) related to an icon change condition (for example, a pedometer count). When it is time for the electronic device to display the health application due to user access to a home screen, the health application may receive change information (for example, at least one of a pedometer count value or information received from a wearable device) from another module (for example, the pedometer application) or a module of a peripheral device (for example, a wearable device), change an icon resource according to the received change information, and display an icon image changed using the change icon resource, as illustrated in (b) of FIG. 10. As illustrated in (c) of FIG. 10, the electronic device may display a new icon image again, to which change information (for example, at least one of a pedometer count value or information received from a wearable device) acquired from the peripheral device is applied according to the change condition.

According to various embodiments, when the electronic device displays an icon representing a health-related application on a screen, the electronic device may collect target achievement state information at the display time of the icon or continuously since the display time of the icon, and display an icon image changed based on the collected target achievement state information, that is, the acquired change information. For example, when the electronic device displays an icon, the electronic device may collect accumulated pedometer data as change information from peripheral devices and display the icon in a shape changed based on the collected data. Also, the electronic device may continuously update the shape of the icon by continuously collecting pedometer data.

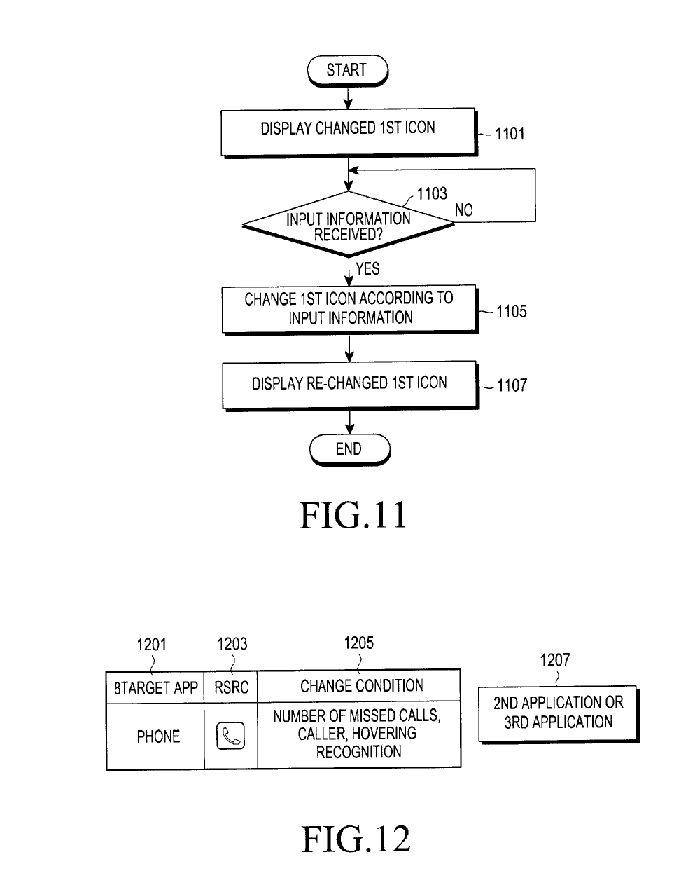

FIG. 11 is a flowchart illustrating an operation procedure for changing an icon in an electronic device according to various embodiments of the present disclosure.

Referring to FIGS. 7 and 11, according to various embodiments of the present disclosure, the electronic device (for example, the electronic device 101 in FIG. 1) may change a first icon representing a first application by applying change information acquired according to a change condition through the operation procedure of FIG. 7, and display the changed first icon on a screen in operation 1101.

In operation 1103, with the first icon displayed, the electronic device may determine whether user input information related to the first icon has been received.

According to various embodiments, upon generation of a user input in a display area of the first icon, the electronic device waits until user input requests display of additional information related to the first icon. When the user input information has been received, the electronic device may perform operation 1105, and otherwise, the electronic device repeats operation 1103.

In operation 1105, the electronic device may change the first icon again in correspondence with the received input information. The electronic device may display the re-changed first icon for the first application in operation 1107.

FIGS. 12 to 15 illustrate block diagrams for changing an icon in an electronic device according to various embodiments of the present disclosure.

Referring to FIG. 12, according to various embodiments, with an icon image 1203 representing, for example, a phone application 1201 as a target application (a first application) displayed, the electronic device may manage an icon resource for the icon image 1203 by applying, to the icon resource, change information acquired from a second application (for example, a recent record processing module) or a third application (for example, a contact module) 1207, which is related to a change condition 1205.

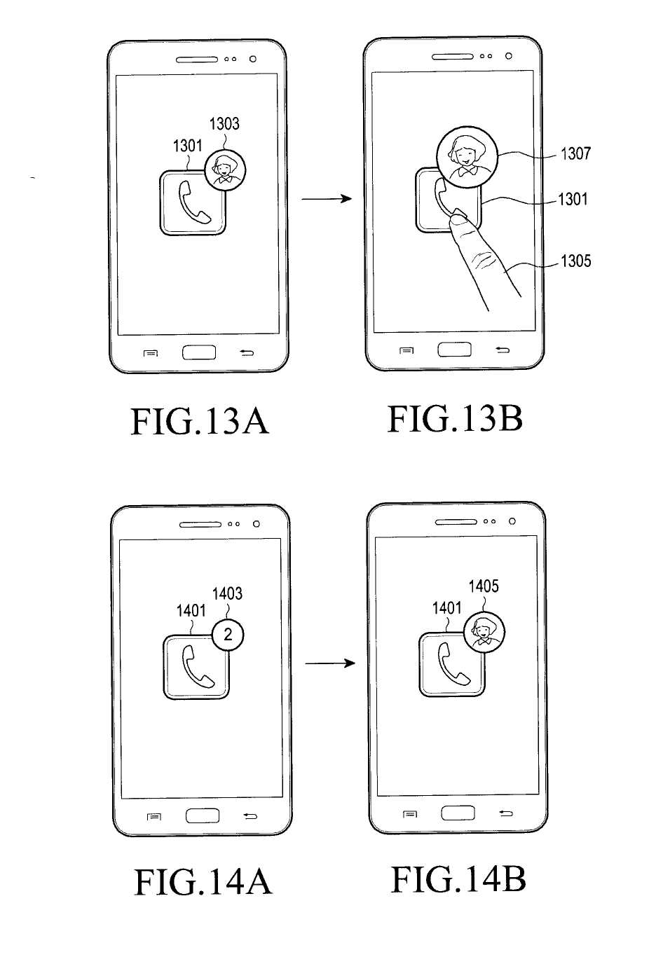

Referring to FIG. 13, the electronic device may perform an operation for re-changing an icon displayed on a screen, for example, according to the operation procedure of FIG. 11. According to various embodiments, after displaying an icon image 1301, the electronic device may display change information acquired according to a change condition as additional information (for example, an additional image 1303 taking the form of a badge) on the icon image 1301, as illustrated in (a) of FIG. 13. According to various embodiments, the electronic device may generate a new icon image by combining the change information with the icon image 1301 and display the new icon image, or may display the change information overlapped with a display area of the icon image 1301 or in the vicinity of the icon image 1301. As illustrated in (b) of FIG. 13, upon receipt of user input information 1305 with the icon reflecting the change information displayed, the electronic device may display an icon image re-changed by changing an image resource of the change information applied to the icon, for example, an icon image to which an additional image 1307 enlarged from the additional image 1303 is applied. According to various embodiments, if a new notification occurs as change information for the phone (call) application, the electronic device may display a target (caller) image in relation to the new notification on the additional image 1303. According to various embodiments, upon receipt of a selection input (touch input) for the enlarged information (badge) from the user, the electronic device may display missed call information related to caller (target) image data included in the additional information or switch to a call log screen displaying missed call information.

Referring to FIG. 14, the electronic device may perform an operation for re-changing an icon displayed on a screen, for example, according to the operation procedure of FIG. 11. According to various embodiments, after displaying an icon image 1401 representing a phone application, the electronic device may display change information acquired according to a change condition as additional information (for example, an additional image 1403 taking the form of a badge where the change condition can be receipt of missed call) on the icon image 1401, as illustrated in (a) of FIG. 14. According to various embodiments, the electronic device may generate a new icon image by combining the change information with the icon image 1401 and display the new icon image, or may display the change information as an additional image 1405 overlapped with a display area of the icon image 1401 or in the vicinity of the icon image 1401. As illustrated in (b) of FIG. 14, upon receipt of user input information with the first icon reflecting the change information displayed, the electronic device may display an icon image re-changed by changing an image resource of the change information applied to the icon, for example, an icon image to which the additional image 1405 (for example, an image based on caller information) is applied. According to various embodiments, if there is a missed call notification (a new notification) on an icon image representing the phone (call) application, the electronic device may display change information (caller image information) acquired from another module related to the missed call notification, that is, another module that is capable of identifying a caller, as a badge on the icon image.

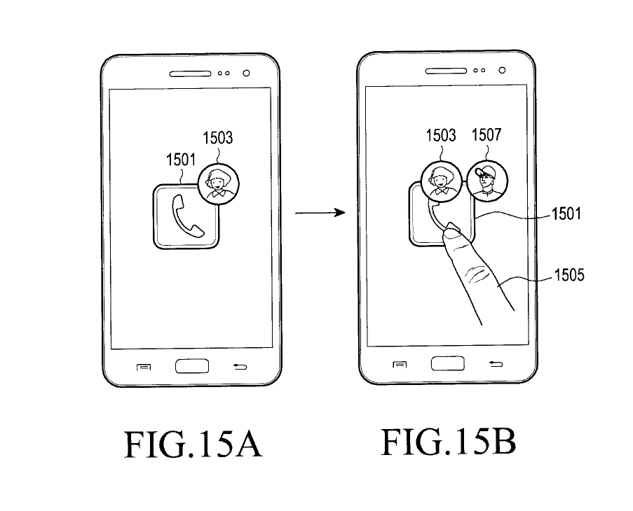

Referring to FIG. 15, according to various embodiments, while an icon including an icon image 1501 representing a call application and change information 1503 added to the icon image 1501 is displayed on a screen, as illustrated in (a) of FIG. 20, upon receipt of change information (for example, images of new notifications), the electronic device may apply the received change information to an icon resource for the icon. Also, upon receipt of user input information 1505, the electronic device may display an icon in which change information 1503 and 1507 are added to the icon image 1501, as illustrated in (b) of FIG. 15. According to various embodiments, the electronic device may display, on a screen, a call icon including a badge to which a most recent caller (target) image is applied. Upon receipt of a hovering input related to a display area of the displayed icon, the electronic device may display a plurality of badge images including at least one non-displayed badge image simultaneously in combination of the call icon or overlapped with the call icon in the display area. According to various embodiments, if a plurality of pieces of additional information (badge objects) related to a plurality of caller images are simultaneously displayed due to a hovering input over the displayed icon, the electronic device may receive a selection (touch) input for at least one of the displayed badge objects. Upon receipt of the selection (touch) input, the electronic device may display new message information related to caller (target) image data of the badge or switch to a screen displaying the message information.

In certain embodiments, when an incoming call is missed, the electronic device receives the calling party's telephone number. From the calling party's telephone number, the electronic device searches a contacts directory for the identity of the calling party. The badge can be from an image in the contacts directory.

The above-described electronic device according to various embodiments of the present disclosure may change an icon image representing an application (or module) to which a theme included in theme data is to be applied by applying change information acquired according to a change condition from another application (or module) included in the electronic device or another electronic device, and display the changed icon image on a screen.

Various embodiments for changing an icon and displaying the changed icon on a screen will be described in detail.

According to various embodiments, the electronic device may display an icon including one or more sticker sets set in theme data to be applied to, for example, various types of icons. Along with application of a theme to a use environment, the electronic device may change icons at one time in such a manner that all objects (for example, icons) displayed on a home screen may include a selected sticker set. As all icons are changed at one time to include the selected sticker set in them, the electronic device may display the icons uniformly according to a concept corresponding to a specific theme. Also, if the sticker set includes a plurality of types, the electronic device may change icons in such a manner that every icon on the home screen may include a sticker set related to at least one of the plurality of types, along with application of a theme to a user environment, according to various embodiments. Each type of the plurality of sticker sets may include specific image data and position data attached to an icon with respect to the object of the icon. The position data may exist as specific coordinate data or a distribution of a transparent area for the image data. The type of a sticker set attached to an icon may be determined according to the type of the icon. For example, if a theme related to a specific character is applied like an icon using a character sticker set of a theme, different types of sticker sets may be attached to an Internet app icon and a directory app icon. The different types of sticker sets attached to the icons may include different image data and different position data related to attachment to the icons.

According to various embodiments, the electronic device may generate an icon image in the form of an animation using an icon resource included in theme data. The animation icon may display at least one of a plurality of images or display a specific image at a changed position, according to a specific condition. The specific condition may be at least one of time, the presence of a notification, a position, movement, a target achievement state, weather, an app state, an upload/download state, a connection state to an external device, or a function use history. According to various embodiments, with an icon representing a call application displayed, the electronic device may determine whether there is a new notification to the call application, such as a missed call notification received from another application or module. In the presence of a new notification, the electronic device may display a changed animation icon that repeats sideway tilting of the call app icon or shaking of the call app icon at a specific angle.

According to various embodiments, when the electronic device displays an icon representing a weather application, the electronic device may collect weather information at a time of displaying the icon or continuously from the time of displaying the icon, change an animation effect of the icon based on the collected weather information, and display the icon with the changed animation effect. For example, if weather information indicating rain is received at a time to display the icon representing the weather application, the electronic device may display the icon with a changed animation effect indicating rain. According to another embodiment, when a screen is switched and it is time to display a weather app icon (animation icon), the icon may be displayed changed based on change information (icon display state or weather information) acquired at the most recent display time of the weather app icon. Then, an image related to a current weather condition may be displayed as an icon image based on acquired change information, and the icon may be displayed with an animation effect of sequential icon image changes. Also, if a screen is activated after weather information is changed from sunny at the last display time of the icon to cloudy, the electronic device may display an animation effect showing sequentially a sunny icon to a cloudy icon. Or if a screen is activated after weather information is changed from rainy at the last display time of the icon to sunny, the electronic device may display an animation effect showing sequentially a rainy icon to a sunny icon.

According to various embodiments, the electronic device may apply various animation effects to an icon representing an application according to various conditions. For example, if data is being uploaded or downloaded in a cloud application, an animation indicating data upload or download may be applied to an icon representing the cloud application. In another example, the electronic device may collect information about an application running in the background at a time to display an icon and display the icon changed by applying an animation indicating execution in progress to the icon of the application.

According to various embodiments, when it is time to display an icon representing an application or module (for example, at least one of a gear manager, an audio controller, a TV controller, or a light controller), the electronic device may check a connection state of the application or module to at least one external device from among a wearable device, a Bluetooth audio player, a connectable display device, or a smart light, and display the icon with an animation indicating whether the application or module is connected to the external device. According to various embodiments, the electronic device may determine whether there is any application unused for a long time, at an icon display time, and display an icon with an animation effect indicating that the application has been left unused for a long time.

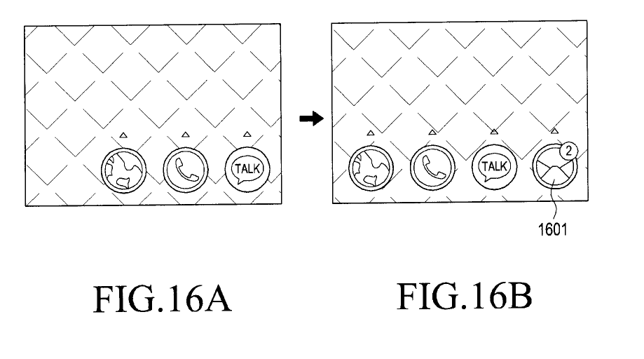

FIGS. 16 to 21 illustrate exemplary screens for changing an icon in an electronic device according to various embodiments of the present disclosure.

Referring to FIG. 16, according to various embodiments, as the electronic device applies a theme to a user environment using an installed theme package, the electronic device may change or add a shortcut on a lock screen, and display an icon representing an application designated as a shortcut application on the lock screen. The electronic device may display icons representing one or more user-selected applications designated as shortcut applications at user-selected positions from among a predetermined plurality of positions, in response to an input received from a user. The positions of the icons may be set based on at least one of use frequencies, time, or positions of the user-selected applications designated as shortcut applications, or weather. The number of the predetermined positions may be limited to a specific value, and the predetermined positions may be changed according to the number of the applications designated as shortcut applications. According to various embodiments, as illustrated in (a) of FIG. 16, the electronic device may display an icon 1601 representing an application selected as a shortcut application by a user at a user-selected position from among predetermined positions on a lock screen. As illustrated in (b) of FIG. 16, upon receipt of change information (a notification) related to, for example, a message application, the electronic device may display an icon 1601 representing the message application to which the change information is applied, at least one of the predetermined plurality of positions, along with at least one other application designated as a shortcut application on the lock screen. The icon 1601 changed for the message application may be displayed, including additional information (for example, a badge) indicating the number of notifications.

According to various embodiments, if the electronic device is to display an icon representing at least one application designated as a shortcut application (for example, the icon 1603 in FIG. 16) and the icon 1601 changed in relation to a new notification at a plurality of predetermined positions, when an additional icon cannot be displayed at the plurality of predetermined positions in a shortcut display area, the electronic device may display an icon representing the application related to the new notification and an icon representing the other application designated as a shortcut application at the plurality of predetermined positions, without the icon representing the displayed at least one application designated as a shortcut application. The non-displayed icon representing the application designated as a shortcut application may be an icon representing an application which is used less frequently. If the display position of an icon representing an application designated as a shortcut application is determined based on the use frequency of the application, the display position of the icon representing the application related to the new notification may have priority over the display position of an icon representing an application previously designated as a shortcut application.

According to various embodiments, the electronic device may display icons together in a group or overlapped with each other on the lock screen, as illustrated in FIG. 16. The order of the applications displayed overlapped may be determined based on use frequencies, the presence or absence of a new notification, or time information related to a new notification. For example, icons may be overlapped in an ascending order of use frequencies. According to various embodiments, the electronic device may display a message application icon having a new notification and a message application icon with the latest notification overlapped with each other in this order. According to various embodiments, if the electronic device displays icons in a group, the electronic device may display additional information indicating the total number of new notifications related to the application icons in the group, as a badge. Upon receipt of a user input related to the displayed group object area, the electronic device may display the icons representing the applications in the group, arranged at a plurality of predetermined positions. When displaying icons representing a plurality of applications designated as shortcut applications or an icon representing an application related to a new notification on the lock screen, the electronic device may display them in at least one group according to a preset condition. The preset condition may include a case where a plurality of icons representing applications are to be displayed on the lock screen or the number of icons representing applications to be displayed is larger than a predetermined number. When displaying icons representing a plurality of applications are displayed in at least one group on the lock screen, the electronic device may display the icons collectively in a predetermined area, and may determine the display positions of the icons by prioritizing the icons according to a preset condition. The preset condition may be at least one of the use frequencies, time, or positions of the applications represented by the icons, or weather.

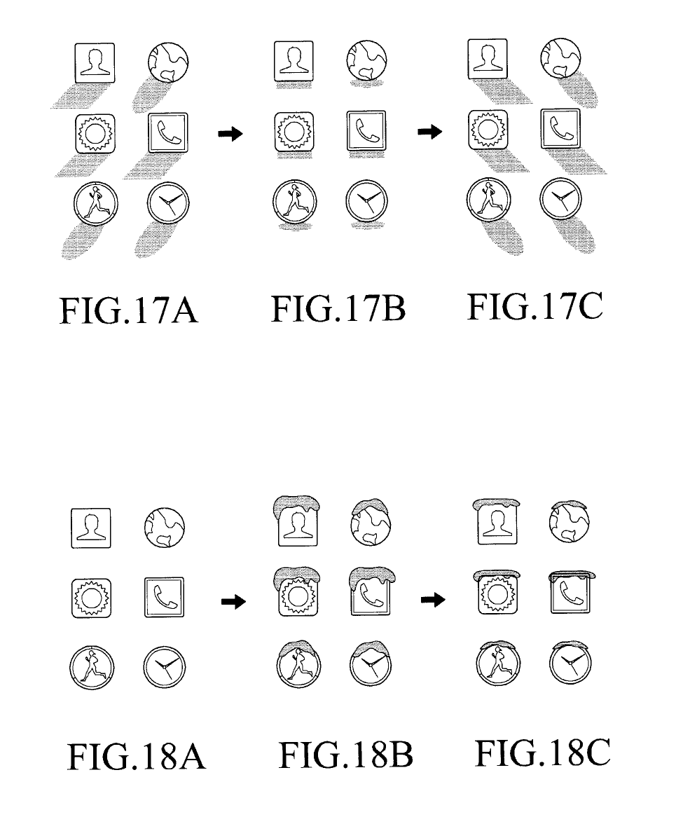

Referring to FIG. 17, according to various embodiments, the electronic device may apply a uniform animation effect based on a specific condition to all icons displayed on a screen (for example, a home screen) by applying a theme to a user environment. The electronic device may generate animation content based on the attribute of each icon to which the animation effect is to be applied, and apply an icon animation according to a common condition (for example, identification information (for example, “All”) 605 about an icon resource in the theme package in FIG. 6). The common condition “All” may include at least one of time, weather, season, or position. According to various embodiments, the electronic device may generate animation content (for example, shadow content) for various icons displayed on a screen and display the icon images of all icons, changed by applying change information that changes the shape or direction of a shadow based on a change condition of the icon resource (for example, the change condition 609 of the icon resource in FIG. 6) such as an icon display time. There may be a plurality of change conditions for the common condition, and an animation may be applied uniformly to icons to be displayed based on the plurality of change conditions.

According to various embodiments, as illustrated in FIG. 17, the electronic device may change all icons at once by applying change information that changes the shape or direction of shadows of the icons to all the icons according to a change condition (for example, a time condition). For example, the electronic device may change the length of the shadows according to a season or change the shade degree of the shadows according to weather and display the icon images with the changed shadows. According to various embodiments, as illustrated in (a) of FIG. 17, the electronic device checks the time when a user has accessed a home screen, as change information. If the change information indicates morning, the electronic device may change all icons displayed on the home screen so that the icons have shadows on the left-hand side. The shadows to the right can signify the sun rising in the Eastern direction (universally the right-hand side of a compass) causing shadows in the opposite or left direction. As illustrated in (b) of FIG. 17, the electronic device checks the time when the user has accessed the home screen again, as change information. If the change information indicates noon, the electronic device may change all icons displayed on the home screen so that the icons may be uniformly shadowed downward. For example, at noon, the sun is usually directly overhead. As illustrated in (c) of FIG. 17, the electronic device checks the time when the user has accessed the home screen, as change information. If the change information indicates afternoon, the electronic device may change all icons displayed on the home screen so that the icons may have shadows on the right-hand side.

Although only change information illustrated only shows morning, noon, and afternoon, in certain embodiments the change information can be considerably more fine, such as hour of the day and respective angle of the shadow. In some embodiments, based on the time, GPS position, and orientation of the electronic device, the location of the sun relative to the electronic device can be determined. Based on the location of the sun relative to the electronic device, the electronic device can determine a line from the location of the sun to the icon. The electronic device can display a shadow along the line, wherein the shadow emerges from the icon along the line opposite to the sun.

Referring to FIG. 18, according to various embodiments, the electronic device may apply a snow accumulation effect to icons according to season and weather information, and change the degree of snow accumulation (a snow melting effect) according to information about a weather and temperature change with passage of time. As illustrated in (a) of FIG. 18, the electronic device may display icons, for example, on a home screen. As illustrated in (b) of FIG. 18, the electronic device may determine to change all of displayed icons representing applications based on identification information (for example, All) about an icon resource in an installed theme package, and display all the icons changed by applying change information (for example, a snow accumulation degree) received from another application according to a change condition (for example, a weather or temperature change) uniformly to the icons. As illustrated in (c) of FIG. 18, upon receipt of change information again, the electronic device may display all the icons changed again by uniformly applying the received change information to the icons.

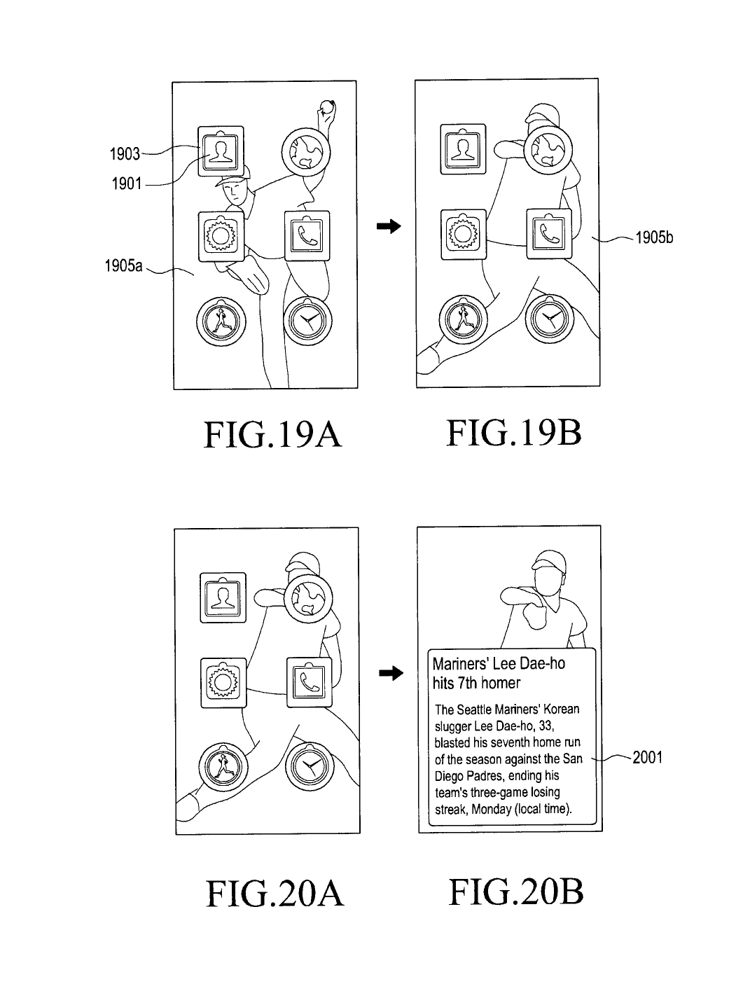

Referring to FIG. 19, according to various embodiments, as the electronic device applies a theme to a user environment, the electronic device may apply at least one of a wallpaper image 1905a or 1905b or an icon 1903, which has been generated according to a predetermined condition out of sports content configured with theme data to be applied or user-selected sports content, to at least one of a wallpaper or an icon 1901 on a screen, as illustrated in (a) of FIG. 19. The theme data to be applied may include content related to at least one of a specific sport, league, team, or player, and the electronic device may determine user-preferred content based on received user input information. The user input information may be profile information input by a user. According to various embodiments, the electronic device may apply a theme related to information about a specific sport, league, team, or player selected according to the user input information. The operation for applying a theme may include applying at least one of the contents, shape, color, or animation of an icon or a background screen. According to various embodiments, the electronic device may update the theme based on sport change information according to user preference information received from a user input. The sport change information may include information about a sport game played during a predetermined period, an MVP in the game, a popular player, an active player, or an interested player. The predetermined time period may be at least one of a time, a day, a week, a month, or a year, and the update may be performed periodically or aperiodically. For example, as illustrated (b) in FIG. 19, the electronic device may generate the icon image 1903 or the wallpaper image 1905a or 1905b in relation to an active player in a sport game played on the same day and display the icon image 1903 or the wallpaper image 1905a or 1905b on the home screen. For example, the icon image 1903 can be a logo for a league that plays the sport.

Referring to FIG. 20, the electronic device may change the visibility of all icons displayed on a home screen including a wallpaper by applying a theme to a user environment. Upon generation of additional content 2001 related to a theme as change information after the icons are displayed on the home screen by applying the theme (for example, a sport) as illustrated in (a) of FIG. 20, the electronic device may provide the additional content 2001 related to an event of the theme (for example, a sport event), with the icons rendered to be invisible, as illustrated in (b) of FIG. 20. The additional content 2001 may be at least one of an article related to the sport event, an SNS, or text, a picture, a sound source, or video content related to a game state or game result, and may be related to the wallpaper image. For example, upon receipt of a specific input from the user, the electronic device may display the article content 2001 related to the sport event along with the wallpaper, without displaying icons, as illustrated in (b) of FIG. 20.

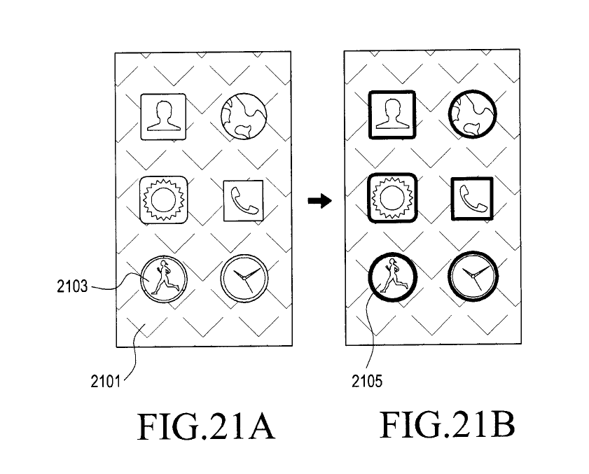

According to various embodiments, when the electronic device displays a changed wallpaper image 2101 by applying a theme to a user environment as illustrated in (a) of FIG. 21, the electronic device may change the frame of at least one application icon 2103 in response to the change of the wallpaper image 2101. The electronic device may check graphic information about the wallpaper image to be changed, and determine visibility information about at least one current displayed or to-be-displayed application icon 2103 based on the graphic information about the wallpaper image. If the visibility information is equal to or lower than a predetermined level, the electronic device may add an icon frame 2105 obtained by changing the outline of the application icon, as illustrated in (b) of FIG. 21. The graphic information about the wallpaper image may be comprehensive data used to configure an image, including an image complexity, distributed colors, or the coordinates, brightness, chrominance, visibility, or resolution of the distributed colors, and the frame may have at least one of the effects of an outline, engraving, embossing, shadowing, spreading, or blurring. Also, the electronic device may determine the new frame based on at least one context from among time, weather, position, season, or user profile according to the graphic information. According to various embodiments, the electronic device may check visibility information about an icon representing an application. If the visibility level of the icon is equal to or lower than a predetermined level, the electronic device may change the outline of the icon as illustrated in (b) of FIG. 21, or add an icon frame having an effect of shadowing or blurring to the icon representing the application.

According to various embodiments, in the case where the electronic device changes the visibility of all icons displayed on a home screen, upon receipt of a specific input from the user, the electronic device may render all of the icons to be invisible to thereby minimize covering of a wallpaper. Further, upon receipt of the same input again or a second input, the electronic device may render the invisible icons to be visible. When displaying an icon with changed visibility, the electronic device may apply various effects to the process of changing the visibility of the icon. The various effects may include card flip-over of each icon or the whole home screen. For example, all icons may be rendered to be invisible on the home screen with a wallpaper displayed as a background image to make the wallpaper image conspicuous, after the process of flipping over the icons or the whole screen in response to a specific user input. According to various embodiments, the electronic device may provide a specific function related to viewing or editing of the wallpaper image in the state where the icons are invisible. If the icons are rendered invisible in response to a specific user input, the electronic device may display the wallpaper image in various manners corresponding to various inputs. The various inputs may include at least one of a button input, a multi-touch input (pinch or zoom-in/zoom-out), a user's gesture input, or a rotation input, and the various manners may include at least one of enlarging, contracting, moving, overlapping, or rotation. If the icons are returned to the visible state in response to a specific user input, the changed wallpaper image may be displayed as a background image of the home screen. For example, on a home screen in which a wallpaper is displayed as a background image and icons are displayed on the wallpaper, the electronic device may change all of the icons to an invisible state in response to a specific user input. Upon receipt of one of various gesture inputs including a pinch and zoom-in input in the state where the icons are invisible, the electronic device may enlarge or move the wallpaper image. The wallpaper image may be displayed changed in response to a user's various inputs, icons may be rendered to be invisible on the home screen in response to a specific user input, and the wallpaper image may be displayed as a background image on the home screen.

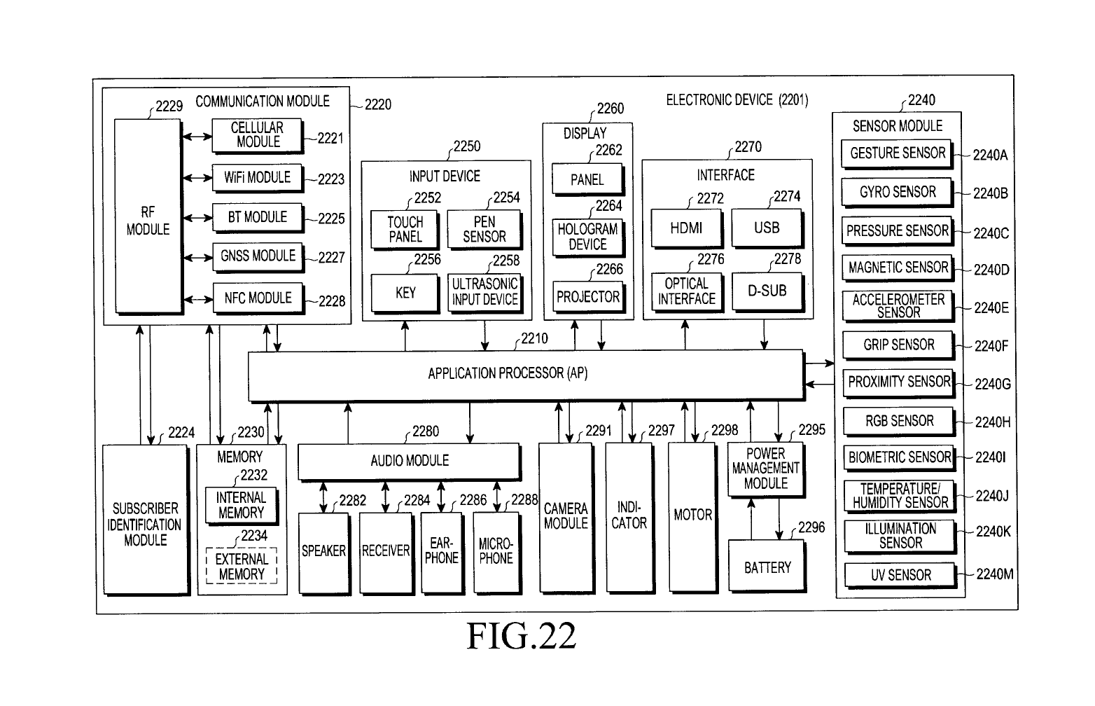

FIG. 22 is a block diagram of an electronic device 2201 according to various embodiments. The electronic device 2201 may include, for example, the whole or part of the electronic device 101 illustrated in FIG. 1. The electronic device 2201 may include at least one processor (for example, AP) 2210, a communication module 2220, a subscriber identification module (SIM) 2224, a memory 2230, a sensor module 2240, an input device 2250, a display 2260, an interface 2270, an audio module 2280, a camera module 2291, a power management module 2295, a battery 2296, an indicator 2297, and a motor 2298.

The processor 2210 may, for example, control a plurality of hardware or software components that are connected to the processor 2210 by executing an OS or an application program and may perform processing or computation of various types of data. The processor 2210 may be implemented, for example, as a system on chip (SoC). According to an embodiment, the processor 2210 may further include a graphics processing unit (GPU) and/or an image signal processor. The processor 2210 may include at least a part (for example, a cellular module 2221) of the components illustrated in FIG. 22. The processor 2210 may load a command or data received from at least one of other components (for example, a non-volatile memory), process the loaded command or data, and store various types of data in the non-volatile memory.

The communication module 2220 may have the same configuration as or a similar configuration to the communication interface 170 illustrated in FIG. 1. The communication module 2220 may include at least one of, for example, the cellular module 2221, a WiFi module 2223, a Bluetooth (BT) module 2225, a GNSS module 2227 (for example, a GPS module, a Glonass module, a Beidou module, or a Galileo module), an NFC module 2228, and a radio frequency (RF) module 2229.

The cellular module 2221 may provide services such as voice call, video call, text service, or the Internet service, for example, through a communication network. According to an embodiment, the cellular module 2221 may identify and authenticate the electronic device 2201 within a communication network, using the SIM (for example, a SIM card) 2224. According to an embodiment, the cellular module 2221 may perform at least a part of the functionalities of the processor 2210. According to an embodiment, the cellular module 2221 may include a CP.

Each of the WiFi module 2223, the BT module 2225, the GNSS module 2227, and the NFC module 2228 may include, for example, a processor that may process data received or transmitted by the module. According to an embodiment, at least a part (for example, two or more) of the cellular module 2221, the WiFi module 2223, the BT module 2225, the GNSS module 2227, or the NFC module 2228 may be included in a single integrated chip (IC) or IC package.

The RF module 2229 may transmit and receive, for example, communication signals (for example, RF signals). The RF module 2229 may include at least one of, for example, a transceiver, a power amplifier module (PAM), a frequency filter, a low noise amplifier (LNA), an antenna, or the like. According to another embodiment, at least one of the cellular module 2221, the WiFi module 2223, the BT module 2225, the GNSS module 2227, or the NFC module 2228 may transmit and receive RF signals via a separate RF module.

The SIM 2224 may include, for example, a card including the SIM and/or an embedded SIM. The SIM 2224 may include a unique identifier (for example, integrated circuit card identifier (ICCID)) or subscriber information (for example, international mobile subscriber identity (IMSI)).

The memory 2230 (for example, the memory 130) may include, for example, an internal memory 2232 and/or an external memory 2234. The internal memory 2232 may be at least one of, for example, a volatile memory (for example, dynamic RAM (DRAM), static RAM (SRAM), or synchronous dynamic RAM (SDRAM)), and a non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash memory, or NOR flash memory), a hard drive, and a solid state driver (SSD).

The external memory 2234 may further include a flash drive such as a compact flash (CF) drive, a secure digital (SD), a micro secure digital (micro-SD), a mini secure digital (mini-SD), an extreme digital (xD), a multi-media card (MMC), or a memory stick. The external memory 2234 may be operatively and/or physically coupled to the electronic device 2201 via various interfaces.

The sensor module 2240 may, for example, measure physical quantities or detect operational states of the electronic device 2201, and convert the measured or detected information into electric signals. The sensor module 2240 may include at least one of, for example, a gesture sensor 2240A, a gyro sensor 2240B, an atmospheric pressure sensor 2240C, a magnetic sensor 2240D, an accelerometer sensor 2240E, a grip sensor 2240F, a proximity sensor 2240G, a color sensor (for example, a red, green, blue (RGB) sensor) 2240H, a biometric sensor 2240I, a temperature/humidity sensor 2240J, an illumination sensor 2240K, or an ultra violet (UV) sensor 2240M. Additionally or alternatively, the sensor module 2240 may include, for example, an electrical-nose (E-nose) sensor, an electromyogram (EMG) sensor, an electroencephaloeram (EEG) sensor, an electrocardiogram (ECG) sensor, an infrared (IR) sensor, an iris sensor, and/or a finger print sensor. The sensor module 2240 may further include a control circuit for controlling one or more sensors included therein. According to some embodiments, the electronic device 2201 may further include a processor configured to control the sensor module 2240, as a part of or separately from the processor 2210. Thus, while the processor 2210 is in a sleep state, the control circuit may control the sensor module 2240.

The input device 2250 may include, for example, a touch panel 2252. The input device 2250 may further include at least one of a (digital) pen sensor 2254, a key 2256, or an ultrasonic input device 2258. The touch panel 2252 may operate in at least one of, for example, capacitive, resistive, infrared, and ultrasonic schemes. The touch panel 2252 may further include a control circuit. The touch panel 2252 may further include a tactile layer to thereby provide haptic feedback to the user.

The (digital) pen sensor 2254 may include, for example, a detection sheet which is a part of the touch panel or separately configured from the touch panel. The key 2256 may include, for example, a physical button, an optical key, or a keypad. The ultrasonic input device 2258 may sense ultrasonic signals generated by an input tool using a microphone (for example, a microphone 2288), and identify data corresponding to the sensed ultrasonic signals.

The display 2260 (for example, the display 160) may include a panel 2262. The display 2260 may further include a hologram device 2264 and/or a projector 2266. The panel 2262 may have the same configuration as or a similar configuration to the display 160 illustrated in FIG. 1. The panel 2262 may be configured to be, for example, flexible, transparent, or wearable. The panel 2262 and the touch panel 2252 may be implemented as a single module. The hologram device 2264 may utilize the interference of light waves to provide a three-dimensional image in empty space. The projector 2266 may display an image by projecting light on a screen. The screen may be positioned, for example, inside or outside the electronic device 2201. According to an embodiment, the display 2260 may further include a control circuit for controlling the panel 2262, the hologram device 2264, or the projector 2266.

The interface 2270 may include at least one of, for example, an HDMI 2272, a USB 2274, an optical interface 2276, or a D-subminiature (D-sub) 2278. The interface 2270 may be included, for example, in the communication interface 170 illustrated in FIG. 1. Additionally or alternatively, the interface 2270 may include, for example, a mobile high-definition link (MHL) interface, an SD/multimedia card (MMC) interface, or an infrared data association (IrDA) interface.

The audio module 2280 may, for example, convert a sound to an electrical signal, and vice versa. At least a part of the components of the audio module 2280 may be included, for example, in the I/O interface 150 illustrated in FIG. 1. The audio module 2280 may process sound information input into, or output from, for example, a speaker 2282, a receiver 2284, an earphone 2286, or the microphone 2288.

The camera module 2291 may capture, for example, still images and a video. According to an embodiment, the camera module 2291 may include one or more image sensors (for example, a front sensor or a rear sensor), a lens, an image signal processor (ISP), or a flash (for example, an LED or a xenon lamp).

The power management module 2295 may manage power of, for example, the electronic device 2201. According to an embodiment, the power management module 2295 may include a power management integrated circuit (PMIC), a charger IC, or a battery or fuel gauge. The PMIC may adopt wired and/or wireless charging. The wireless charging may be performed, for example, in a magnetic resonance scheme, a magnetic induction scheme, or an electromagnetic wave scheme, and may further include an additional circuit for wireless charging, for example, a coil loop, a resonance circuit, or a rectifier. The battery gauge may measure, for example, a charge level, a voltage while charging, current, or temperature of the battery 2296. The battery 2296 may include, for example, a rechargeable battery and/or a solar battery.

The indicator 2297 may indicate specific states of the electronic device 2201 or a part of the electronic device 2201 (for example, the processor 2210), for example, boot status, message status, or charge status. The motor 2298 may convert an electrical signal into a mechanical vibration and generate vibrations or a haptic effect. While not shown, the electronic device 2201 may include a processing device for supporting mobile TV (for example, a GPU). The processing device for supporting mobile TV may process media data compliant with, for example, digital multimedia broadcasting (DMB), digital video broadcasting (DVB), or MediaFLO™.

Each of the above-described components of the electronic device may include one or more parts and the name of the component may vary with the type of the electronic device. According to various embodiments, the electronic device may be configured to include at least one of the afore-described components. Some component may be omitted from or added to the electronic device. According to various embodiments, one entity may be configured by combining a part of the components of the electronic device, to thereby perform the same functions of the components prior to the combining.

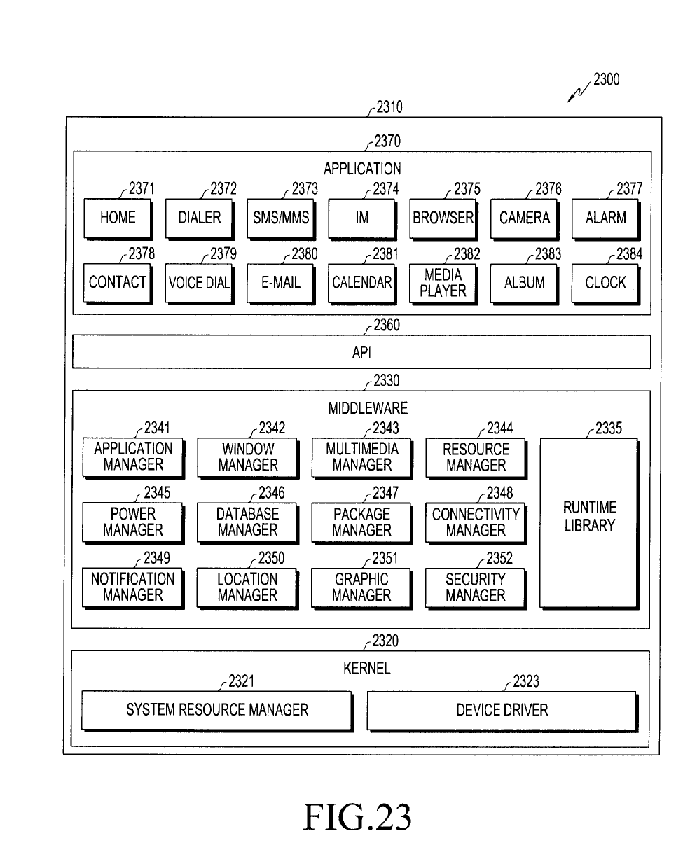

FIG. 23 is a block diagram of a programming module according to various embodiments of the present disclosure. According to an embodiment, a programming module 2310 (for example, a program 140) may include an OS that controls resources related to an electronic device (for example, the electronic device 101) and/or various applications executed on the OS (for example, the application programs 147). For example, the OS may be Android, iOS, Windows, Symbian, Tizen, Bada, or the like.

The programming module 2310 may include a kernel 2320, middleware 2330, an Application Programming Interface (API) 2360, and/or applications 2370. At least a part of the programming module 2310 may be preloaded on the electronic device or downloaded from an external electronic device (for example, the electronic device 102 or 104, or the server 106).

The kernel 2320 (for example, the kernel 141) may include, for example, a system resource manager 2321 and/or a device driver 2323. The system resource manager 2321 may control, allocate, or deallocate system resources. According to an embodiment, the system resource manager 2321 may include at least one of a process manager, a memory manager, or a file system manager. The device driver 2323 may include, for example, a display driver, a camera driver, a Bluetooth driver, a shared memory driver, a USB driver, a keypad driver, a WiFi driver, an audio driver, or an inter-process communication (IPC) driver.

The middleware 2330 may, for example, provide a function required commonly for the applications 2370 or provide various functionalities to the applications 2370 through the API 2360 so that the applications 2370 may efficiently use limited system resources available within the electronic device. According to an embodiment, the middleware 2330 (for example, the middleware 143) may include at least one of a runtime library 2335, an application manager 2341, a window manager 2342, a multimedia manager 2343, a resource manager 2344, a power manager 2345, a database manager 2346, a package manager 2347, a connectivity manager 2348, a notification manager 2349, a location manager 2350, a graphic manager 2351, or a security manager 2352.

The runtime library 2335 may include, for example, a library module that a complier uses to add a new function in a programming language during execution of an application 2370. The runtime library 2335 may perform input/output management, memory management, a function related to arithmetic function, or the like.

The application manager 2341 may manage, for example, the life cycle of at least one of the applications 2370. The window manager 2342 may manage GUI resources used for a screen. The multimedia manager 2343 may determine formats required to play back various media files and may encode or decode a media file using a CODEC suitable for the format of the media file. The resource manager 2344 may manage resources such as a source code of at least one of the applications 2370, a memory, or storage space.

The power manager 2345 may, for example, manage a battery or a power source by operating in conjunction with a basic input/output system (BIOS) and may provide power information required for an operation of the electronic device. The database manager 2346 may generate, search, or modify a database for at least one of the applications 2370. The package manager 2347 may manage installation or update of an application distributed as a package file.

The connectivity manager 2348 may manage, for example, wireless connectivity of WiFi, Bluetooth, or the like. The notification manager 2349 may indicate or notify an event such as message arrival, a schedule, a proximity alarm, or the like in a manner that does not bother a user. The location manager 2350 may mange position information about the electronic device. The graphic manager 2351 may manage graphical effects to be provided to the user or related user interfaces. The security manager 2352 may provide an overall security function required for system security, user authentication, or the like. In an embodiment, if the electronic device (for example, the electronic device 101) has a telephony function, the middleware 2330 may further include a telephony manager to manage a voice or video call function of the electronic device.

A new middleware module may be created and used by combining various functions of the above-described component modules in the middleware 2330. The middleware 2330 may provide a customized module for each OS type in order to provide differentiated functions. In addition, the middleware 2330 may dynamically delete a part of the existing components or add a new component.

The API 2360 (for example, the API 145) is, for example, a set of API programming functions, which may be configured differently according to an OS. For example, in the case of Android or iOS, one API set may be provided per platform, whereas in the case of Tizen, two or more API sets may be provided per platform.

The applications 2370 (for example, the application programs 147) may include, for example, one or more applications capable of providing functions such as home 2371, dialer 2372, short message service/multimedia messaging service (SMS/MMS) 2373, Instant message (IM) 2374, browser 2375, camera 2376, alarm 2377, contacts 2378, voice dial 2379, email 2380, calendar 2381, media player 2382, album 2383, or clock 2384, health care (for example, measurement of an exercise amount or a glucose level), or providing of environment information (for example, information about atmospheric pressure, humidity, or temperature).

According to an embodiment, the applications 2370 may include an application (for the convenience of description, referred to as ‘information exchange application’) supporting information exchange between the electronic device (for example, the electronic device 101) and an external electronic device (the electronic device 102 or 104). The information exchange application may include, for example, a notification relay application for transmitting specific information to the external electronic device or a device management application for managing the external electronic device.

For example, the notification relay application may include a function of transmitting notification information generated from another application (for example, an SMS/MMS application, an email application, a health care application, or an environment information application) to the external electronic device (for example, the electronic device 102 or 104). Also, the notification relay application may, for example, receive notification information from the external electronic device and transmit the received notification information to a user.

The device management application may, for example, manage (for example, install, delete, or update) at least a part of functions of the external electronic device (for example, the electronic device 102 or 104) communicating with the electronic device (for example, turn-on/turn-off of the external electronic device (or a part of its components) or control of the brightness (or resolution) of the display), an application executed in the external electronic device, or a service (for example, a call service or a message service) provided by the external electronic device.

According to an embodiment, the applications 2370 may include an application (for example, a health care application of a mobile medical equipment) designated according to a property of the external electronic device (for example, the electronic device 102 or 104). According to an embodiment, the applications 2370 may include an application received from an external electronic device (for example, the server 106 or the electronic device 102 or 104). According to an embodiment, the applications 2370 may include a preloaded application or a third party application downloadable from a server. The names of components of the programming module 2310 according to the embodiment of the present disclosure may vary according to the type of an OS.

According to various embodiments, at least a part of the programming module 2310 may be implemented in software, firmware, hardware, or a combination of at least two of them. At least a part of the programming module 2310 may be implemented (for example, executed) by the processor (for example, the processor 210). At least a part of the programming module 2310 may include, for example, a module, a program, a routine, a set of instructions, or a process to execute one or more functions.

As is apparent from the foregoing description of the electronic device and method for operating the electronic device according to various embodiments, the electronic device can determine states, information, and the like related to other functions linked to an application as well as information provided by the application, just by checking an icon representing the application.

The term ‘module’ as used herein may include its ordinary meaning including, for example, a unit of one, or hardware, hardware with memory storing executable instructions, or a combination thereof. The term ‘module’ may be used interchangeably with terms such as, for example, unit, logic, logical block, component or circuit. A ‘module’ may be the smallest unit of an integrated part or a portion thereof. A ‘module’ may be the smallest unit for performing one or more functions, or a portion thereof. A ‘module’ may be implemented mechanically, or electronically. For example, a ‘module’ may include at least one of a known, or to-be-developed, application-specific integrated circuit (ASIC) chip, field-programmable gate array (FPGA) or programmable logic device that perform certain operations.

At least a part of apparatuses (for example, modules or their functions) or methods (for example, operations) according to various embodiments may be implemented as commands stored in a computer-readable storage medium, in the form of a programming module. When the commands are executed by a processor (for example, the processor 120), one or more processors may execute functions corresponding to the commands. The computer-readable storage medium may be, for example, the memory 130.

The computer-readable medium may include hard disk, floppy disk, magnetic media (for example, magnetic tape), optical media (for example, compact disc read-only memory (CD-ROM)), digital versatile disc (DVD), magneto-optical media (for example, floptical disk), hardware devices (for example, read-only memory (ROM), random access memory (RAM) or flash memory)), and the like. Program instructions may include machine language code that are produced by a compiler or high-level language code that may be executed by a computer using an interpreter. The functionalities of hardware discussed above may be implemented as one or more software modules, and vice versa in order to perform an operation according to various embodiments.

A module or a programming module according to various embodiments may include one or more of the above-described components, may omit a portion thereof, or may include additional components. Operations that are performed by a module, a programming module or other components according to the present disclosure may be processed in a serial, parallel, repetitive or heuristic manner. Also, some operations may be performed in a different order or omitted, or additional operations may be added.

According to various embodiments, in a computer-readable recording medium recording a program to be executed by a computer, the program includes instructions configured to, when a processor executes the instructions, control the processor to display a first icon representing a first application or function on the display, for user selection of the first application or function, to provide the first application or function with content data related to a change which has occurred to a second application or function different from the first application or function, and to contract or modify at least a part of the content data and display the contracted or modified content data overlapped with at least a part of the first icon or in the vicinity of the first icon.

According to various embodiments, in a computer-readable recording medium recording a program to be executed by a computer, the program includes instructions configured to, when a processor executes the instructions, control the processor to display a first icon for execution of a first application on the display, to change the first icon based on information provided by a second application different from the first application, and to display the changed first icon.

The embodiments disclosed in the present specification are provided for description and understanding of the present disclosure, not limiting the scope of the present disclosure. Accordingly, the scope of the present disclosure should be interpreted as embracing all modifications or various embodiments within the scope of the present disclosure therein.

What is claimed is:

1. An electronic device comprising:
a display;
a processor electrically connected to the display; and
a memory electrically connected to the processor, wherein the memory stores instructions for, when the instructions are executed, causing the processor to:
display a first icon configured for user selection of a first application or function on the display,
provide the first application or function with content data related to a change which has occurred to a second application or function different from the first application or function,
change at least a part of the content data, and
display the changed content data overlapped with at least a part of the first icon or in the vicinity of the first icon.

2. The electronic device of claim 1, wherein the content data includes at least one of a picture, an image symbol, or text, and
wherein the change is one of call termination, message reception, weather, temperature, current time, use time, a user's biometric state, or a user input..

3. The electronic device of claim 1, wherein the instructions enable the processor to acquire the first icon, format information, and change information from an external device, the format information and the change information being used for displaying at least one content data overlapped with at least a part of the first icon or in the vicinity of the first icon.

4. The electronic device of claim 1, wherein the instructions cause the processor to change the at least partially changed content data based on a status of the electronic device or an external electronic device connected to the electronic device, and
wherein the external electronic device is at least one of a server or a companion device of the electronic device.

5. An electronic device comprising:
a display; and
a controller configured to control display of a first icon for execution of a first application on the display, and change of the first icon based on information provided by a second application different from the first application.

6. The electronic device of claim 5, wherein the controller controls display of the first icon based on an icon resource included in a theme package installed in the electronic device, change of the first icon of the first application using information acquired from the second application according to a change condition included in the theme package, the second application being related to the change condition, and display of the changed first icon.

7. The electronic device of claim 6, wherein the controller controls storing of the theme package separately as event data and resource data, and display of the first icon by applying the icon resource included in the theme package to the first application.

8. The electronic device of claim 6, wherein the theme package includes event data including at least one of information about a change condition for changing the first icon, identification information about the first application, and at least one of an icon resource for the first application.

9. The electronic device of claim 6, wherein upon generation of a user input for the changed first icon after the first icon is changed, the controller controls display of the changed first icon together with additional information configured by applying information acquired from the second application according to the user input.

10. The electronic device of claim 5, wherein the controller controls change of at least one of a shape, a color, an animation effect, an icon frame, an icon display state, or an icon position of the first icon according to at least one of time, weather, preferred content, a position, or an application use frequency based on information provided by the second application, and display of the changed first icon.

11. The electronic device of claim 7, wherein the controller controls change of all icons displayed on a screen including the first icon by applying change information to all of the first icon and other icons displayed on the screen, and display of the changed icons on the screen.

12. A method for changing an icon in an electronic device, the method comprising:
displaying a first icon configured for user selection of a first application or function on a display of the electronic device;
providing the first application or function with content data related to a change which has occurred to a second application or function different from the first application or function; and
changing at least a part of the content data, and
displaying the changed content data overlapped with at least a part of the first icon or in the vicinity of the first icon.

13. A method for changing an icon in an electronic device, the method comprising:
displaying a first icon for execution of a first application on a display of the electronic device;
changing the first icon based on information provided by a second application different from the first application; and
displaying the changed first icon.

14. The method of claim 13, wherein the displaying of a first icon for execution of a first application comprises displaying the first icon based on an icon resource included in a theme package installed in the electronic device.

15. The method of claim 13, wherein the changing of the first icon based on information provided by a second application comprises:
checking a change condition included in a theme package installed in the electronic device; and
changing the first icon using the information acquired from the second application related to the change condition, according to the change condition.

16. The method of claim 15, wherein the theme package includes event data including at least one of information about a change condition for changing the first icon, identification information about the first application, and at least one of an icon resource for the first application.

17. The method of claim 13, further comprising:
upon generation of a user input for the changed first icon after the first icon is changed, acquiring information provided by the second application according to the user input; and
displaying additional information configured by applying the acquired information, along with the changed first icon.

18. The method of claim 13, wherein the displaying of the changed first icon comprises changing of at least one of a shape, a color, an animation effect, an icon frame, an icon display state, or an icon position of the first icon according to at least one of time, weather, preferred content, a position, or an application use frequency based on information provided by the second application, and displaying the changed first icon.

19. The method of claim 13, further comprising changing all icons displayed on a screen including the first icon by applying change information to all of the first icon and other icons displayed on the screen, and displaying the changed icons on the screen.

20. A computer-readable recording medium recording a program to be executed by a computer, the program including executable instructions configured to, when a processor executes the instructions, control the processor to perform:
displaying a first icon for execution of a first application on a display;
changing the first icon based on information provided by a second application different from the first application; and
displaying the changed first icon.
